(19) United States
(12) Patent Application Publication
(10) Pub. No.: US 2024/0192513 A1
(43) Pub. Date: Jun. 13, 2024

(54) RGB THREE-COLOR LASER LIGHT SOURCE SYNTHESIS AND BEAM SPLITTING DEVICES

(71) Applicants: SYNDIANT, INC., DALLAS, TX (US); XDMicro (Zhongshan) Optoelectronic Semiconductor Co., Ltd., Zhongshan (CN)

(72) Inventor: Sheng Hsiung CHAN, DALLAS, TX (US)

(21) Appl. No.: 18/469,275

(22) Filed: Sep. 18, 2023

(30) Foreign Application Priority Data
Dec. 7, 2022 (CN) 202211560982.0

(51) Int. Cl. G02B 27/10; G02B 27/14

(52) U.S. Cl. CPC G02B 27/1006; G02B 27/145

(57) ABSTRACT

The present application provides an RGB three-color laser light source synthesis and beam splitting device, including: a light source assembly including first light sources, a second light source, and a third light source; light splitters; light filters and/or reflectors, and light homogenizer. The light splitters, and the light filters and/or the reflectors are used in combination to perform multi-pass reflection and splitting on the light rays emitted from the light source assembly, so that multiple light rays are generated on the main light paths to realize the beam expansion. The first light rays, the second light rays, and the third light rays subjected to the beam expansion can be uniformly incident on the light homogenizer, and be subjected to secondary homogenization by the light homogenizer.

### CROSS-REFERENCE TO RELATED APPLICATION

This application claims priority to and the benefit of Chinese Patent Application No. 202211560982.0, filed on Dec. 7, 2022, the disclosure of which is incorporated herein by reference in its entirety.

### TECHNICAL FIELD

The present application relates to projection display technologies, and more particularly, to RGB three-color laser light source synthesis and beam splitting devices.

### BACKGROUND

Many RGB three-color laser light source synthesis and beam splitting devices have used semiconductor laser light sources as light sources because of characteristics of the semiconductor laser light sources, such as a small volume, a high luminous efficiency and a high color purity. However, a semiconductor laser light source is a divergent light source and has different divergence angles respectively in different directions, so that a cross-section of a light spot generated by the semiconductor laser light source has an elliptical shape, which may deteriorate the use efficiency of a light homogenizer in a projection optical system. Thus, there is a need to increase a width of a beam in one direction.

A monolithic RGB three-color laser light source synthesis and beam splitting device will require beam expansion or beam splitting when using the semiconductor laser light source. Generally, RGB three-color light sources are used to sequentially light up and illuminate a projection panel through an optical system, so a dichroic mirror is used to synthesize the RGB three-color light onto the same light path. However, due to characteristics of an elliptical cross-section of the light spot of the semiconductor laser, the use area of the light homogenizer may be reduced without a unidirectional beam expansion or beam splitting device in the light synthesis process, and thus the effect of light homogenization cannot meet design requirements. Therefore, it may be necessary to add a beam expander to perform unidirectional beam expansion operation on light rays. Although the beam expander may improve uniformity of the system, the volume and cost of the entire system will be increased due to the complex structure of the beam expander.

### SUMMARY

In view of the above, an embodiment of the present application provides an RGB three-color laser light source synthesis and beam splitting device, having main light paths extending in a first direction and side light paths extending in a second direction perpendicular to the first direction; the RGB three-color laser light source synthesis and beam splitting device includes: a light source assembly including first light sources, a second light source, and a third light source, where the first light sources are disposed in the main light paths to emit first light rays in the first direction, the second light source is disposed in the side light paths to emit second light rays in the second direction, and the third light source is disposed in the side light paths to emit third light rays in the second direction; light splitters capable of transmitting a portion of the first light rays, a portion of the second light rays, and a portion of the third light rays, and reflecting remaining portion of the first light rays, remaining portion of the second light rays, and remaining portion of the third light rays; and light filters capable of transmitting one or two of the first light rays, the second light rays, and the third light rays and reflecting remainder of the first light rays, the second light rays, or the third light rays; and/or reflectors capable of reflecting the first light rays, the second light rays, and the third light rays; where the light splitters, the light filters, and/or the reflectors are capable of conducting the first light rays, the second light rays, and the third light rays to the first direction.

Optionally, in an embodiment of the present application, the main light paths include a first main light path and a second main light path, where the second main light path is disposed in parallel with the first main light path. The side light paths include a first side light path and a second side light path, where the second side light path is disposed in parallel with the first side light path. The light filters are disposed at an intersection of the first main light path and the first side light path to transmit the first light rays and reflect the second light rays to the first direction. The light splitters are disposed at an intersection of the first main light path and the second side light path to transmit the portion of the first light rays and reflect the remaining portion of the first light rays to the second direction, transmit the portion of the second light rays and reflect the remaining portion of the second light rays to the second direction, and transmit the portion of the third light rays and reflect the remaining portion of the third light rays to the first direction. The reflectors are disposed at an intersection of the second main light path and the second side light path to reflect the first light rays, the second light rays, and the third light rays from the second direction to the first direction.

Optionally, in an embodiment of the present application, the light filters are configured to at least transmit the first light rays and reflect the second light rays. The light splitters are configured to transmit ½ of the first light rays and reflect ½ of the first light rays, transmit ½ of the second light rays and reflect ½ of the second light rays, and transmit ½ of the third light rays and reflect ½ of the third light rays. The reflectors are configured to reflect the first light rays, the second light rays, and the third light rays.

Optionally, in an embodiment of the present application, the main light paths include a first main light path and a second main light path, where the second main light path is disposed in parallel with the first main light path. The side light paths include a first side light path and a second side light path, where the second side light path is disposed in parallel with the first side light path. The light splitters include a first light splitter and a second light splitter, where the first light splitter is disposed at an intersection of the first main light path and the first side light path to transmit the portion of the first light rays and reflect the remaining portion of the first light rays to the second direction, and transmit the portion of the second light rays and reflect the remaining portion of the second light rays to the second direction. The second light splitter is disposed at an intersection of the first main light path and the second side light path to transmit the first light rays, the second light rays, and the portion of the third light rays, and reflect the remaining portion of the third light rays to the first direction. The reflectors are disposed at an intersection of the second main light path and the first side light path to reflect the first light rays and the second light rays from the second direction to the first direction. The light filters are disposed at an intersection of the second main light path and the second side light path to transmit the first light rays and the second light rays, and reflect the third light rays to the first direction.

Optionally, in an embodiment of the present application, the first light splitter is configured to at least transmit ½ of the first light rays and reflect ½ of the first light rays, and transmit ½ of the second light rays and reflect ½ of the second light rays. The second light splitter is configured to transmit the first light rays, the second light rays, and ½ of the third light rays and reflect ½ of the third light rays. The reflectors are configured to at least reflect the first light rays and the second light rays. The light filters are configured to transmit the first light rays and the second light rays, and reflect the third light rays.

Optionally, in an embodiment of the present application, the main light paths include a first main light path, a second main light path, and a third main light path, where the first main light path, the second main light path, and the third main light path are disposed parallel to each other. The side light paths include a first side light path and a second side light path, where the second side light path is disposed in parallel with the first side light path. The light filters are disposed at an intersection of the first main light path and the first side light path to transmit the first light rays and reflect the second light rays to the first direction. The light splitters include a first light splitter and a second light splitter, where the first light splitter is disposed at an intersection of the first main light path and the second side light path to transmit the portion of the first light rays and reflect the remaining portion of the first light rays to the second direction, transmit the portion of the second light rays and reflect the remaining portion of the second light rays to the second direction, and transmit the portion of the third light rays and reflect the remaining portion of the third light rays to the first direction; and the second light splitter is disposed at an intersection of the second main light path and the second side light path to transmit the portion of the first light rays and reflect the remaining portion of the first light rays to the first direction, transmit the portion of the second light rays and reflect the remaining portion of the second light rays to the first direction, and transmit the portion of the third light rays and reflect the remaining portion of the third light rays to the first direction. The reflectors are disposed at an intersection of the third main light path and the second side light path to reflect the first light rays, the second light rays, and the third light rays from the second direction to the first direction.

Optionally, in an embodiment of the present application, the light filters are configured to at least transmit the first light rays and reflect the second light rays. The first light splitter is configured to transmit ⅓ of the first light rays and reflect ⅔ of the first light rays, transmit ⅓ of the second light rays and reflect ⅔ of the second light rays, and transmit ⅔ of the third light rays and reflect ⅓ of the third light rays. The second light splitter is configured to transmit ½ of the first light rays and reflect ½ of the first light rays, transmit ½ of the second light rays and reflect ½ of the second light rays, and transmit ½ of the third light rays and reflect ½ of the third light rays. The reflectors are configured to reflect the first light rays, the second light rays, and the third light rays.

Optionally, in an embodiment of the present application, the main light paths include a first main light path, a second main light path, and a third main light path, where the first main light path, the second main light path, and the third main light path are disposed parallel to each other. The side light paths include a first side light path and a second side light path, where the second side light path is disposed in parallel with the first side light path. The light splitters include a first light splitter, a second light splitter, a third light splitter, and a fourth light splitter, where the first light splitter is disposed at an intersection of the first main light path and the first side light path to transmit the portion of the first light rays and reflect the remaining portion of the first light rays to the second direction, and transmit the portion of the second light rays and reflect the remaining portion of the second light rays to the second direction; the second light splitter is disposed at an intersection of the first main light path and the second side light path to transmit the first light rays, the second light rays, and the portion of the third light rays, and reflect the remaining portion of the third light rays to the first direction; the third light splitter is disposed at an intersection of the second main light path and the first side light path, to transmit the portion of the first light rays and reflect the remaining portion of the first light rays to the second direction, transmit the portion of the second light rays and reflect the remaining portion of the second light rays to the second direction; and the fourth light splitter is disposed at an intersection of the second main light path and the second side light path to transmit the first light rays, the second light rays, and the portion of the third light rays and reflect the remaining portion of the third light rays to the first direction. The reflectors are disposed at an intersection of the third main light path and the first side light path to reflect the first light rays and the second light rays from the second direction to the first direction. The light filters are disposed at an intersection of the third main light path and the second side light path to transmit the first light rays and the second light rays, and reflect the third light rays to the first direction.

Optionally, in an embodiment of the present application, the first light splitter is configured to at least transmit ⅓ of the first light rays and reflect ⅔ of the first light rays, and transmit ⅔ of the second light rays and reflect ⅓ of the second light rays. The second light splitter is configured to transmit the first light rays, the second light rays, and ⅔ of the third light rays and reflect ⅓ of the third light rays. The third light splitter is configured to at least transmit ½ of the first light rays and reflect ½ of the first light rays, and transmit ½ of the second light rays and reflect ½ of the second light rays. The fourth light splitter is configured to transmit the first light rays, the second light rays, and ½ of the third light rays and reflect ½ of the third light rays. The reflectors are configured to at least reflect the first light rays and the second light rays. The light filters are configured to transmit the first light rays and the second light rays, and reflect the third light rays.

Optionally, in an embodiment of the present application, the main light paths include a first main light path, a second main light path, a third main light path, and a fourth main light path, wherein the first main light path, the second main light path, the third main light path, and the fourth main light path are disposed parallel to each other. The side light paths include a first side light path and a second side light path, where the second side light path is disposed in parallel with the first side light path.

The light filters are disposed at an intersection of the first main light path and the first side light path to transmit the first light rays and reflect the second light rays to the first direction. The light splitters include a first light splitter, a second light splitter, and a third light splitter, where the first light splitter is disposed at an intersection of the first main light path and the second side light path to transmit the portion of the first light rays and reflect the remaining portion of the first light rays to the second direction, transmit the portion of the second light rays and reflect the remaining portion of the second light rays to the second direction, and transmit the portion of the third light rays and reflect the remaining portion of the third light rays to the first direction; the second light splitter is disposed at an intersection of the second main light path and the second side light path to transmit the portion of the first light rays and reflect the remaining portion of the first light rays to the first direction, transmit the portion of the second light rays and reflect the remaining portion of the second light rays to the first direction, and transmit the portion of the third light rays and reflect the remaining portion of the third light rays to the first direction; and the third light splitter is disposed at an intersection of the third main light path and the second side light path to transmit the portion of the first light rays and reflect the remaining portion of the first light rays to the first direction, transmit the portion of the second light rays and reflect the remaining portion of the second light rays to the first direction, and transmit the portion of the third light rays and reflect the remaining portion of the third light rays to the first direction. The reflectors are disposed at an intersection of the fourth main light path and the second side light path to reflect the first light rays, the second light rays, and the third light rays from the second direction to the first direction.

Optionally, in an embodiment of the present application, the light filters are configured to at least transmit the first light rays and reflect the second light rays. The first light splitter is configured to transmit ¼ of the first light rays and reflect ¾ of the first light rays, transmit ¼ of the second light rays and reflect ¾ of the second light rays, and transmit ¾ of the third light rays and reflect ¼ of the third light rays. The second light splitter is configured to transmit ⅔ of the first light rays and reflect ⅓ of the first light rays, transmit ⅔ of the second light rays and reflect ⅓ of the second light rays, and transmit ⅔ of the third light rays and reflect ⅓ of the third light rays. The third light splitter is configured to transmit ½ of the first light rays and reflect ½ of the first light rays, transmit ½ of the second light rays and reflect ½ of the second light rays, and transmit ½ of the third light rays and reflect ½ of the third light rays. The reflectors are configured to reflect the first light rays, the second light rays, and the third light rays.

Optionally, in an embodiment of the present application, the main light paths include a first main light path and a second main light path, where the second main light path is disposed in parallel with the first main light path. The side light paths include a first side light path and a second side light path, where the second side light path is disposed in parallel with the first side light path. The first light sources are disposed in the first main light path and the second main light path, respectively. The second light source is disposed in the first side light path. The third light source is disposed in the second side light path.

Optionally, in an embodiment of the present application, the light splitters include a first light splitter and a second light splitter, where the first light splitter is disposed at an intersection of the first main light path and the first side light path to transmit the first light rays and the portion of the second light rays and reflect the remaining portion of the second light rays to the second direction. The second light splitter is disposed at an intersection of the first main light path and the second side light path to transmit the first light rays, the second light rays, and the portion of the third light rays, and reflect the remaining portion of the third light rays to the first direction. The light filters include a first light filter and a second filter element, where the first light filter is disposed at an intersection of the second main light path and the first side light path to transmit the first light rays and reflect the second light rays to the first direction, and the second light filter is disposed at an intersection of the second main light path and the second side light path to transmit the first light rays and the second light rays, and reflect the third light rays to the first direction.

Optionally, in an embodiment of the present application, the first light splitter is configured to at least transmit the first light rays and ½ of the second light rays and reflect ½ of the second light rays. The second light splitter is configured to transmit the first light rays, the second light rays, and ½ of the third light rays and reflect ½ of the third light rays. The first light filter is configured to at least transmit the first light rays and reflect the second light rays. The second light filter is configured to transmit the first light rays and the second light rays, and reflect the third light rays.

Optionally, in an embodiment of the present application, the first light source, the second light source, and the third light source all have the same luminous intensity.

Optionally, in an embodiment of the present application, the sum of the luminous brightness of the first light source disposed in the first main light path and the luminous brightness of the first light source disposed in the second main light path is the same as the luminous brightness of the second light source. The sum of the luminous brightness of the first light source disposed in the first main light path and the luminous brightness of the first light source disposed in the second main light path is the same as the luminous brightness of the third light source.

Optionally, in an embodiment of the present application, the main light paths include a first main light path, a second main light path, and a third main light path, where the first main light path, the second main light path, and the third main light path are disposed parallel to each other. The side light paths include a first side light path and a second side light path, where the second side light path is disposed in parallel with the first side light path. The first light sources are disposed in the first main light path, the second main light path, and the third main light path, respectively. The second light source is disposed in the first side light path. The third light source is disposed in the second side light path.

Optionally, in an embodiment of the present application, the light splitters include a first light splitter, a second light splitter, a third light splitter, and a fourth light splitter, where the first light splitter is disposed at an intersection of the first main light path and the first side light path to transmit the first light rays and the portion of the second light rays and reflect the remaining portion of the second light rays to the second direction; the second light splitter is disposed at an intersection of the first main light path and the second side light path to transmit the first light rays, the second light rays, and the portion of the third light rays, and reflect the remaining portion of the third light rays to the first direction; the third light splitter is disposed at an intersection of the second main light path and the first side light path, to transmit the first light rays and the portion of the second light rays and reflect the remaining portion of the second light rays to the second direction; and the fourth light splitter is disposed at an intersection of the second main light path and the second side light path to transmit the first light rays, the second light rays, and the portion of the third light rays and reflect the remaining portion of the third light rays to the first direction. The light filters include a first light filter and a second light filter, where the first light filter is disposed at an intersection of the third main light path and the first side light path to transmit the first light rays and reflect the second light rays to the first direction; and the second light filter is disposed at an intersection of the third main light path and the second side light path to transmit the first light rays and the second light rays, and reflect the third light rays to the first direction.

Optionally, in an embodiment of the present application, the first light splitter is configured to at least transmit the first light rays and ⅓ of the second light rays, and reflect ⅔ of the second light rays. The second light splitter is configured to transmit the first light rays, the second light rays, and ⅔ of the third light rays and reflect ⅓ of the third light rays. The third light splitter is configured to at least transmit the first light rays and ½ of the second light rays and reflect ½ of the second light rays. The fourth light splitter is configured to transmit the first light rays, the second light rays, and ½ of the third light rays and reflect ½ of the third light rays. The first light filter is configured to at least transmit the first light rays and reflect the second light rays. The second light filter is configured to transmit the first light rays and the second light rays, and reflect the third light rays.

Optionally, in an embodiment of the present application, the first light source, the second light source, and the third light source all have the same luminous intensity.

Optionally, in an embodiment of the present application, the sum of the luminous brightness of the first light source disposed in the first main light path, the luminous brightness of the first light source disposed in the second main light path, and the luminous brightness of the first light source disposed in the third main light path is the same as the luminous brightness of the second light source. The sum of the luminous brightness of the first light source disposed in the first main light path, the luminous brightness of the first light source disposed in the second main light path, and the luminous brightness of the first light source disposed in the third main light path is the same as the luminous brightness of the third light source.

Optionally, in an embodiment of the present application, the main light paths include a first main light path, a second main light path, and a third main light path, where the first main light path, the second main light path, and the third main light path are arranged parallel to each other. The side light paths include a first side light path and a second side light path, where the second side light path is disposed in parallel with the first side light path. The light splitters include a first light splitter and a second light splitter, where the first light splitter is disposed at an intersection of the first main light path and the first side light path and extends to an intersection of the second main light path and the second side light path to transmit the portion of the first light rays and reflect the remaining portion of the first light rays, transmit the portion of the second light rays and reflect the remaining portion of the second light rays, and transmit the portion of the third light rays and reflect the remaining portion of the third light rays. The second light splitter is disposed at an intersection of the first main light path and the second side light path to transmit the first light rays, the second light rays, and the portion of the third light rays, and reflect the remaining portion of the third light rays to the first direction. The reflectors are disposed at an intersection of the second main light path and the first side light path and extends to an intersection of the third main light path and the second side light path to reflect the first light rays, the second light rays, and the third light rays from the second direction to the first direction.

Optionally, in an embodiment of the present application, the first light splitter is configured to transmit ½ of the first light rays and reflect ½ of the first light rays, transmit ½ of the second light rays and reflect ½ of the second light rays, and transmit ½ of the third light rays and reflect ½ of the third light rays. The second light splitter is configured to transmit ⅔ of the first light rays and reflect ⅓ of the first light rays, transmit ⅔ of the second light rays and reflect ⅓ of the second light rays, and transmit ⅔ of the third light rays and reflect ⅓ of the third light rays. The reflectors are configured to reflect the first light rays, the second light rays, and the third light rays.

Optionally, in an embodiment of the present application, the main light paths include a first main light path, a second main light path, and a third main light path, where the first main light path, the second main light path, and the third main light path are disposed parallel to each other. The side light paths include a first side light path and a second side light path, where the second side light path is disposed in parallel with the first side light path. The light splitters include a first light splitter, a second light splitter, and a third light splitter, where the first light splitter is disposed at an intersection of the first main light path and the first side light path to transmit the portion of the first light rays and reflect the remaining portion of the first light rays to the second direction, and transmit the portion of the second light rays and reflect the remaining portion of the second light rays to the second direction; the second light splitter is disposed at an intersection of the first main light path and the second side light path to transmit the first light rays, the second light rays, and the portion of the third light rays, and reflect the remaining portion of the third light rays to the first direction; the third light splitter is disposed at an intersection of the second main light path and the second side light path, to transmit the portion of the first light rays and reflect the remaining portion of the first light rays to the second direction, transmit the portion of the second light rays and reflect the remaining portion of the second light rays to the second direction, and transmit the portion of the third light rays and reflect the remaining portion of the third light rays to the first direction. The reflectors include a first reflector and a second reflector, where the first reflector is disposed at an intersection of the second main light path and the first side light path to reflect the first light rays and the second light rays from the second direction to the first direction. The second reflector is disposed at an intersection of the third main light path and the second side light path to reflect the first light rays, the second light rays and the third light rays from the second direction to the first direction.

Optionally, in an embodiment of the present application, the first light splitter is configured to at least transmit ⅓ of the first light rays and reflect ⅔ of the first light rays, and transmit ⅔ of the second light rays and reflect ⅓ of the second light rays. The second light splitter is configured to transmit the first light rays, the second light rays, and ⅔ of the third light rays and reflect ⅓ of the third light rays. The third light splitter is configured to at least transmit ½ of the first light rays and reflect ½ of the first light rays, transmit ½ of the second light rays and reflect ½ of the second light rays, and transmit ½ of the third light rays and reflect ½ of the third light rays. The first reflector is configured to at least reflect the first light rays and the second light rays. The second reflector is configured to reflect the first light rays, the second light rays, and the third light rays.

Optionally, in an embodiment of the present application, the main light paths include a first main light path, a second main light path, a third main light path, and a fourth main light path, where the first main light path, the second main light path, the third main light path, and the fourth main light path are disposed parallel to each other. The side light paths include a first side light path, and a second side light path, where the second side light path is disposed in parallel with the first side light path. The light splitters include a first light splitter, a second light splitter, a third light splitter, a fourth light splitter, and a fifth light splitter, where the first light splitter is disposed at an intersection of the first main light path and the first side light path to transmit the portion of the first light rays and reflect the remaining portion of the first light rays to the second direction, and transmit the portion of the second light rays and reflect the remaining portion of the second light rays to the second direction; the second light splitter is disposed at an intersection of the first main light path and the second side light path to transmit the first light rays, the second light rays, and the portion of the third light rays, and reflect the remaining portion of the third light rays to the first direction; the third light splitter is disposed at an intersection of the second main light path and the second side light path, to transmit the portion of the first light rays and reflect the remaining portion of the first light rays to the second direction, transmit the portion of the second light rays and reflect the remaining portion of the second light rays to the second direction; the fourth light splitter is disposed at an intersection of the second main light path and the second side light path to transmit the first light rays, the second light rays, and the portion of the third light rays and reflect the remaining portion of the third light rays to the first direction; and the fifth light splitter is disposed at an intersection of the second main light path and the second side light path to transmit the portion of the first light rays and reflect the remaining portion of the first light rays to the second direction, transmit the portion of the second light rays and reflect the remaining portion of the second light rays to the second direction, and transmit the portion of the third light rays and reflect the remaining portion of the third light rays to the first direction. The reflectors include a first reflector and a second reflector, where the first reflector is disposed at an intersection of the third main light path and the first side light path to reflect the first light rays and the second light rays from the second direction to the first direction, and the second reflector is disposed at an intersection of the fourth main light path and the second side light path to reflect the first light rays, the second light rays and third light rays from the second direction to the first direction.

Optionally, in an embodiment of the present application, the first light splitter is configured to at least transmit ¼ of the first light rays and reflect ¾ of the first light rays, and transmit ¾ of the second light rays and reflect ¼ of the second light rays. The second light splitter is configured to transmit the first light rays, the second light rays, and ¾ of the third light rays and reflect ¼ of the third light rays. The third light splitter is configured to at least transmit ⅓ of the first light rays and reflect ⅔ of the first light rays, and transmit ⅔ of the second light rays and reflect ⅓ of the second light rays. The fourth light splitter is configured to transmit the first light rays, the second light rays, and ⅔ of the third light rays and reflect ⅓ of the third light rays. The fifth light splitter is configured to at least transmit ½ of the first light rays and reflect ½ of the first light rays, transmit ½ of the second light rays and reflect ½ of the second light rays, and transmit ½ of the third light rays and reflect ½ of the third light rays. The first reflector is configured to at least reflect the first light rays and the second light rays. The second reflector is configured to reflect the first light rays, the second light rays and the third light rays.

Optionally, in an embodiment of the present application, the RGB three-color laser light source synthesis and beam splitting device further includes a light homogenizer capable of uniformly emitting the first light rays, the second light rays, and the third light rays, where the light splitters, the light filters, and the reflectors can be capable of conducting the first light rays, the second light rays, and the third light rays to the light homogenizer, and the light homogenizer can enable the first light rays, the second light rays, and the third light rays to be uniformly emitted from the first direction.

Optionally, in an embodiment of the present application, the light homogenizer includes a compound eye lens.

Optionally, in an embodiment of the present application, the light source assembly includes a laser light source. The first light rays, the second light rays, and the third light rays are laser light rays of different colors, respectively.

Optionally, in an embodiment of the present application, the light filters are disposed at an included angle of 45 degree to the first direction and the second direction, respectively. The light splitters are disposed at an included angle of 45 degree to the first direction and the second direction, respectively. The reflectors are disposed at an included angle of 45 degree to the first direction and the second direction, respectively.

### BRIEF DESCRIPTION OF THE DRAWINGS

FIG. 1 is a schematic structural diagram of an RGB three-color laser light source synthesis and beam splitting device according to an embodiment of the present application.

FIG. 2 is a schematic structural diagram of an RGB three-color laser light source synthesis and beam splitting device according to another embodiment of the present application.

FIG. 3 is a schematic structural diagram of an RGB three-color laser light source synthesis and beam splitting device according to another embodiment of the present application.

FIG. 4 is a schematic structural diagram of an RGB three-color laser light source synthesis and beam splitting device according to another embodiment of the present application.

FIG. 5 is a schematic structural diagram of an RGB three-color laser light source synthesis and beam splitting device according to another embodiment of the present application.

FIG. 6 is a schematic structural diagram of an RGB three-color laser light source synthesis and beam splitting device according to another embodiment of the present application.

FIG. 7 is a schematic structural diagram of an RGB three-color laser light source synthesis and beam splitting device according to another embodiment of the present application.

FIG. 8 is a schematic structural diagram of an RGB three-color laser light source synthesis and beam splitting device according to another embodiment of the present application.

FIG. 9 is a schematic structural diagram of an RGB three-color laser light source synthesis and beam splitting device according to another embodiment of the present application.

FIG. 10 is a schematic structural diagram of an RGB three-color laser light source synthesis and beam splitting device according to another embodiment of the present application.

FIG. 11 is a schematic structural diagram of an RGB three-color laser light source synthesis and beam splitting device according to another embodiment of the present application.

FIG. 12 is a schematic structural diagram of an RGB three-color laser light source synthesis and beam splitting device according to another embodiment of the present application.

### DETAILED DESCRIPTION

Some embodiments of the present application will be described in detail below in conjunction with the drawings, but not intended to limit the present disclosure.

In the description of the present application, it should be understood that orientations or position relationships indicated by the terms “center”, “upper”, “lower”, “front”, “rear”, “left”, “right”, “vertical”, “horizontal”, “top”, “bottom”, “inside”, “outside” are based on orientations or position relationships illustrated in the drawings. The terms are used to facilitate and simplify the description of the present application, rather than indicate or imply that the devices or elements referred to herein are required to have specific orientations or be constructed or operate in the specific orientations. Accordingly, the terms should not be construed as limiting the present application.

The terms “first”, “second” are for illustrative purposes only and are not to be construed as indicating or imposing a relative importance or implicitly indicating the number of technical features indicated. Thus, a feature that limited by “first”, “second” may expressly or implicitly include at least one of the features. In the description of the present application, the meaning of “plurality” is two or more, unless otherwise specifically defined.

The present application provides an RGB three-color laser light source synthesis and beam splitting device 1, which is described in detail below. It should be noted that the description order of the following embodiments of the present application is not intended to limit the preferred order of the embodiments. In the following embodiments, descriptions of the embodiments are emphasized. A portion that is not described in detail in an embodiment may refer to related descriptions in another embodiment.

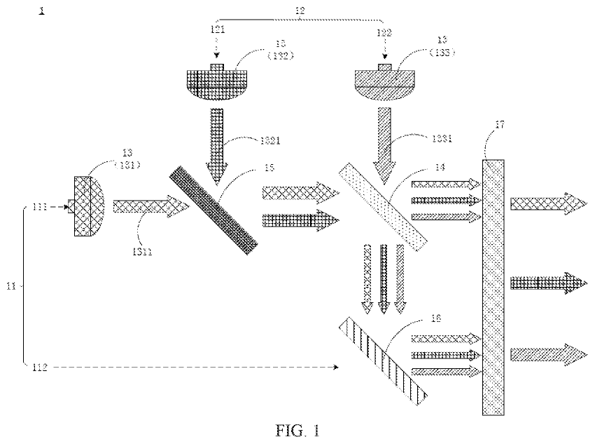

Referring to FIGS. 1 to 12, the present application provides an RGB three-color laser light source synthesis and beam splitting device 1, including a light source assembly 13, light splitters 14, light filters 15 and/or reflectors 16, and a light homogenizer 17. It should be understood that the RGB three-color laser light source synthesis and beam splitting device 1 includes at least one of the light filters 15 and/or the reflectors 16.

An embodiment that the RGB three-color laser light source synthesis and beam splitting device 1 includes both the light filters 15 and/or the reflectors 16 is introduced below.

Referring to FIGS. 1 to 5, the present application provides an RGB three-color laser light source synthesis and beam splitting device 1, having main light paths 11 extending in a first direction X and side light paths 12 extending in a second direction Y perpendicular to the first direction X. The RGB three-color laser light source synthesis and beam splitting device 1 includes: a light source assembly 13 including first light sources 131, a second light source 132, and a third light source 133, where the first light sources 131 are disposed in the main light paths 11 to emit first light rays 1311 in the first direction X, the second light source 132 is disposed in the side light paths 12 to emit second light rays 1321 in the second direction Y, and the third light source 133 is disposed in the side light paths 12 to emit third light rays 1331 in the second direction Y; light splitters 14 capable of transmitting a portion of the first light rays 1311, a portion of the second light rays 1321, and a portion of the third light rays 1331, and reflecting remaining portion of the first light rays 1311, remaining portion of the second light rays 1321, and remaining portion of the third light rays 1331; light filters 15 capable of transmitting one or two of the first light rays 1311, the second light rays 1321, and the third light rays 1331 and reflecting remainder of the first light rays 1311, the second light rays 1321, or the third light rays 1331; reflectors 16 capable of reflecting the first light rays 1311, the second light rays 1321, and the third light rays 1331; and a light homogenizer 17 capable of uniformly emit the first light rays 1311, the second light rays 1321, and the third light rays 1331; where the light splitters 14, the light filters 15, and the reflectors 16 can be capable of conducting the first light rays 1311, the second light rays 1321, and the third light rays 1331 to the light homogenizer 17, and the light homogenizer 17 can enable the first light rays 1311, the second light rays 1321, and the third light rays 1331 to be uniformly emitted from the first direction X. The light splitters 14, the light filters 15, and the reflectors 16 are used in combination in the RGB three-color laser light source synthesis and beam splitting device 1 of the present application to perform multi-pass reflection and splitting on the light rays emitted from the light source assembly 13, so that multiple light rays are generated on the main light paths 11 to realize the beam expansion. The first light rays 1311, the second light rays 1321, and the third light rays 1331 subjected to the beam expansion can be uniformly incident on the light homogenizer 17 and be subjected to secondary homogenization by the light homogenizer 17. Thus, with no additional separate beam expander, the effect of homogenization of the exit light rays from the RGB three-color laser light source synthesis and beam splitting device 1 is improved by using the simple planar structure.

As shown in FIG. 1, in an embodiment of the present application, the main light paths 11 include a first main light path 111 and a second main light path 112, where the second main light path 112 is disposed in parallel with the first main light path 111. The side light paths 12 include a first side light path 121 and a second side light path 122, where the second side light path 122 is disposed in parallel with the first side light path 121. The light filters 15 are disposed at an intersection of the first main light path 111 and the first side light path 121 to transmit the first light rays 1311 and reflect the second light rays 1321 to the first direction X. The light splitters 14 are disposed at an intersection of the first main light path 111 and the second side light path 122 to transmit the portion of the first light rays 1311 and reflect the remaining portion of the first light rays 1311 to the second direction Y, transmit the portion of the second light rays 1321 and reflect the remaining portion of the second light rays 1321 to the second direction Y, and transmit the portion of the third light rays 1331 and reflect the remaining portion of the third light rays 1331 to the first direction X. The reflectors 16 are disposed at an intersection of the second main light path 112 and the second side light path 122 to reflect the first light rays 1311, the second light rays 1321, and the third light rays 1331 from the second direction Y to the first direction X.

Specifically, the light filters 15 are configured to at least transmit the first light rays 1311 and reflect the second light rays 1321. The light splitters 14 are configured to transmit ½ of the first light rays 1311 and reflect ½ of the first light rays 1311, transmit ½ of the second light rays 1321 and reflect ½ of the second light rays 1321, and transmit ½ of the third light rays 1331 and reflect ½ of the third light rays 1331. The reflectors 16 are configured to reflect the first light rays 1311, the second light rays 1321, and the third light rays 1331.

That is, the first light rays 1311 emitted by the first light source 131 in the first direction X are all transmitted through the light filters 15 disposed at the intersection of the first main light path 111 and the first side light path 121. Then, ½ of the first light rays 1311 are transmitted through the light splitters 14 disposed at the intersection of the first main light path 111 and the second side light path 122 and incident on the light homogenizer 17, while the remaining ½ of the first light rays 1311 are reflected by the light splitters 14 to the reflectors 16 disposed at the intersection of the second main light path 112 and the second side light path 122, and the first light rays 1311 are reflected by the reflectors 16 from the second direction Y to the first direction X, and then are incident on the light homogenizer 17. The second light rays 1321 emitted by the second light source 132 in the second direction Y are all reflected by the filter elements 15 disposed at the intersection of the first main light path 111 and the first side light path 121 to the first direction X. Then, ½ of the second light rays 1321 are transmitted through the light splitters 14 disposed at the intersection of the first main light path 111 and the second side light path 122 and incident on the light homogenizer 17, while the remaining ½ of the second light rays 1321 are reflected by the light splitters 14 to the reflectors 16 disposed at the intersection of the second main light path 112 and the second side light path 122, and the second light rays 1321 are reflected by the reflectors 16 from the second direction Y to the first direction X, and then are incident on the light homogenizer 17. ½ of the third light rays 1331 emitted by the third light source 133 in the second direction Y are reflected by the light splitters 14 disposed at the intersection of the first main light path 111 and the second side light path 122 to the first direction X, and then are incident on the light homogenizer 17, while the remaining ½ of the third light rays 1331 are transmitted through the light splitters 14 and incident on the reflectors 16 disposed at the intersection of the second main light path 112 and the second side light path 122, and the third light rays 1331 are reflected by the reflectors 16 from the second direction Y to the first direction X and then incident on the light homogenizer 17. Therefore, the first light rays 1311, the second light rays 1321, and the third light rays 1331 that are incident on the light homogenizer 17 are changed from one path to two paths, respectively, so that an area of the light paths that are incident on the light homogenizer 17 is expanded to realize the beam expansion. Further, the light rays are subjected to secondary homogenization by the light homogenizer 17, so that the effect of homogenization of the exit light rays from the RGB three-color laser light source synthesis and beam splitting device 1 is improved by using the simple planar structure without adding the separate beam expander.

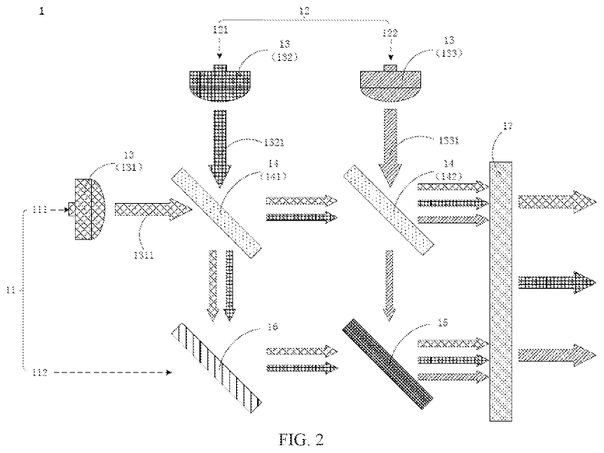

As shown in FIG. 2, in an embodiment of the present application, the main light paths 11 include a first main light path 111 and a second main light path 112, where the second main light path 112 is disposed in parallel with the first main light path 111. The side light paths 12 include a first side light path 121 and a second side light path 122, where the second side light path 122 is disposed in parallel with the first side light path 121. The light splitters 14 include a first light splitter 141 and a second light splitter 142, where the first light splitter 141 is disposed at an intersection of the first main light path 111 and the first side light path 121 to transmit the portion of the first light rays 1311 and reflect the remaining portion of the first light rays 1311 to the second direction Y, and transmit the portion of the second light rays 1321 and reflect the remaining portion of the second light rays 1321 to the second direction Y. The second light splitter 142 is disposed at an intersection of the first main light path 111 and the second side light path 122 to transmit the first light rays 1311, the second light rays 1321, and the portion of the third light rays 1331, and reflect the remaining portion of the third light rays 1331 to the first direction X. The reflectors 16 are disposed at an intersection of the second main light path 112 and the first side light path 121 to reflect the first light rays 1311 and the second light rays 1321 from the second direction Y to the first direction X. The light filters 15 are disposed at an intersection of the second main light path 112 and the second side light path 122 to transmit the first light rays 1311 and the second light rays 1321, and reflect the third light rays 1331 to the first direction X.

Specifically, in an embodiment of the present application, the first light splitter 141 is configured to at least transmit ½ of the first light rays 1311 and reflect ½ of the first light rays 1311, and transmit ½ of the second light rays 1321 and reflect ½ of the second light rays 1321. The second light splitter 142 is configured to transmit the first light rays 1311, the second light rays 1321, and ½ of the third light rays 1331 and reflect ½ of the third light rays 1331. The reflectors 16 are configured to at least reflect the first light rays 1311 and the second light rays 1321. The light filters 15 are configured to transmit the first light rays 1311 and the second light rays 1321, and reflect the third light rays 1331.

That is, ½ of the first light rays 1311 emitted by the first light source 131 in the first direction X are transmitted through the first light splitter 141 disposed at the intersection of the first main light path 111 and the first side light path 121 and then the first light rays 1311 transmitted through the first light splitter 141 are all transmitted through the second light splitter 142 disposed at the intersection of the first main light path 111 and the second side light path 122 and incident on the light homogenizer 17, while the remaining ½ of the first light rays 1311 are reflected by the first light splitter 141 to the reflectors 16 disposed at the intersection of the second main light path 112 and the first side light path 121 and then the first light rays 1311 are all reflected by the reflectors 16 from the second direction Y to the first direction X, and then are transmitted through the light filters 15 disposed at the intersection of the second main light path 112 and the second side light path 122 to the light homogenizer 17. ½ of the second light rays 1321 emitted by the second light source 132 in the second direction Y are transmitted through the first light splitter 141 disposed at the intersection of the first main light path 111 and the first side light path 121 and the second light rays 1321 transmitted through the first light splitter 141 are all reflected by the reflectors 16 disposed at the intersection of the second main light path 112 and the first side light path 121 to the first direction X and then all transmitted through the light filters 15 disposed at the intersection of the second main light path 112 and the second side light path 122 to the light homogenizer 17, while the remaining ½ of the second light rays 1321 are reflected by the first light splitter 141 disposed at the intersection of the first main light path 111 and the first side light path 121 to the second light splitter 142 disposed at the intersection of the first main light path 111 and the second side light path 122, and then transmitted through the second light splitter 142 and incident on the light homogenizer 17. ½ of the third light rays 1331 emitted by the third light source 133 in the second direction Y are reflected by the second light splitter 142 disposed at the intersection of the first main light path 111 and the second side light path 122 to the first direction X, and then are incident on the light homogenizer 17, while the remaining ½ of the third light rays 1331 are transmitted through the second light splitter 142 and incident on the light filters 15, and the third light rays 1331 transmitted through the light filters 15 are reflected from the second direction Y to the first direction X and then incident on the light homogenizer 17. Therefore, the first light rays 1311, the second light rays 1321, and the third light rays 1331 that are incident on the light homogenizer 17 are changed from one path to two paths, respectively, so that an area of the light paths that are incident on the light homogenizer 17 is expanded to realize the beam expansion. Further, the light rays are subjected to secondary homogenization by the light homogenizer 17, so that the effect of homogenization of the exit light rays from the RGB three-color laser light source synthesis and beam splitting device 1 is improved by using the simple planar structure without adding the separate beam expander.

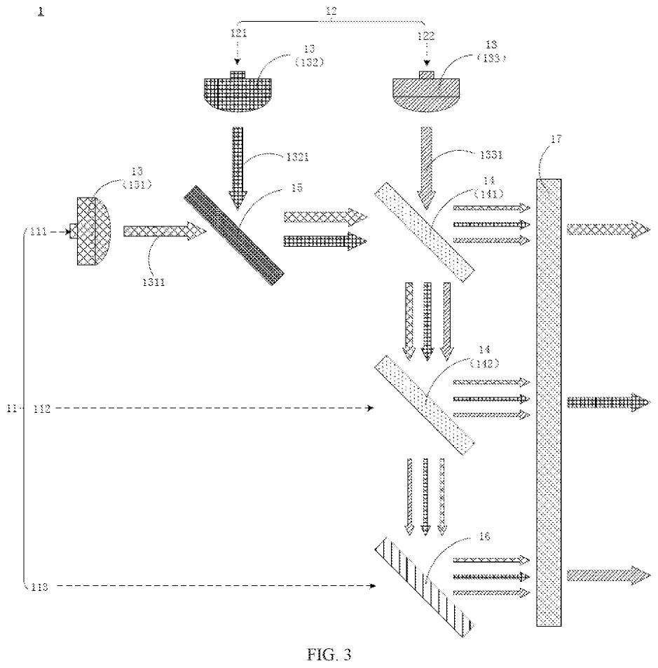

As shown in FIG. 3, in an embodiment of the present application, the main light paths 11 include a first main light path 111, a second main light path 112, and a third main light path 113, where the first main light path 111, the second main light path 112, and the third main light path 113 are disposed parallel to each other. The side light paths 12 include a first side light path 121 and a second side light path 122, where the second side light path 122 is disposed in parallel with the first side light path 121. The light filters 15 are disposed at an intersection of the first main light path 111 and the first side light path 121 to transmit the first light ray 1311 and reflect the second light ray 1321 to the first direction X. The light splitters 14 include a first light splitter 141 and a second light splitter 142, where the first light splitter 141 is disposed at an intersection of the first main light path 111 and the second side light path 122 to transmit the portion of the first light rays 1311 and reflect the remaining portion of the first light rays 1311 to the second direction Y, transmit the portion of the second light rays 1321 and reflect the remaining portion of the second light rays 1321 to the second direction Y, and transmit the portion of the third light rays 1331 and reflect the remaining portion of the third light rays 1331 to the first direction X; and the second light splitter 142 is disposed at an intersection of the second main light path 112 and the second side light path 122 to transmit the portion of the first light rays 1311 and reflect the remaining portion of the first light rays 1311 to the first direction X, transmit the portion of the second light rays 1321 and reflect the remaining portion of the second light rays 1321 to the first direction X, and transmit the portion of the third light rays 1331 and reflect the remaining portion of the third light rays 1331 to the first direction X. The reflectors 16 are disposed at an intersection of the third main light path 113 and the second side light path 122 to reflect the first light rays 1311, the second light rays 1321, and the third light rays 1331 from the second direction Y to the first direction X.

Specifically, the light filters 15 are configured to at least transmit the first light rays 1311 and reflect the second light rays 1321. The first light splitter 141 is configured to transmit ⅓ of the first light rays 1311 and reflect ⅔ of the first light rays 1311, transmit ⅓ of the second light rays 1321 and reflect ⅔ of the second light rays 1321, and transmit ⅔ of the third light rays 1331 and reflect ⅓ of the third light rays 1331. The second light-splitting 142 is configured to transmit ½ of the first light rays 1311 and reflect ½ of the first light rays 1311, transmit ½ of the second light rays 1321 and reflect ½ of the second light rays 1321, and transmit ½ of the third light rays 1331 and reflect ½ of the third light rays 1331. The reflectors 16 are configured to reflect the first light rays 1311, the second light rays 1321, and the third light rays 1331.

That is, the first light rays 1311 emitted by the first light sources 131 in the first direction X are all transmitted through the light filters 15 disposed at the intersection of the first main light path 111 and the first side light path 121. Then, ⅓ of the first light rays 1311 are transmitted through the first light splitter 141 disposed at the intersection of the first main light path 111 and the second side light path 122 and incident on the light homogenizer 17, while the remaining ⅔ of the first light rays 1311 are reflected by the first light splitter 141 to the second light splitter 142 disposed at the intersection of the second main light path 112 and the second side light path 122. ½ of the first light rays 1311 incident on the second light splitter 142 are reflected to the light homogenizer 17, while the remaining ½ of the first light rays 1311 incident on the second light splitter 142 are transmitted through the second light splitter 142 to the reflectors 16 disposed at the intersection of the third main light path 113 and the second side light path 122, and the first light rays 1311 are reflected by the reflectors 16 from the second direction Y to the first direction X and then incident on the light homogenizer 17. The second light rays 1321 emitted by the second light source 132 in the second direction Y are all reflected by the filter elements 15 disposed at the intersection of the first main light path 111 and the first side light path 121 to the first direction X. Then, ⅓ of the second light rays 1321 are transmitted through the first light splitter 141 disposed at the intersection of the first main light path 111 and the second side light path 122 and incident on the light homogenizer 17, while the remaining ⅔ of the second light rays 1321 are reflected by the first light splitter 141 to the second light splitter 142 disposed at the intersection of the second main light path 112 and the second side light path 122. ½ of the second light rays 1321 incident on the second light splitter 142 are reflected to the light homogenizer 17, while the remaining ½ of the second light rays 1321 incident on the second light splitter 142 is transmitted through the second light splitter 142 to reflectors 16 disposed at the intersection of the third main light path 113 and the second side light path 122, and the second light rays 1321 are reflected by the reflectors 16 from the second direction Y to the first direction X and then incident on the light homogenizer 17. ⅓ of the third light rays 1331 emitted by the third light source 133 in the second direction Y are all reflected by the first light splitter 141 disposed at the intersection of the first main light path 111 and the second side light path 122 to the first direction X and then incident on the light homogenizer 17, while remaining ⅔ of the third light rays 1331 are transmitted through the first light splitter 141 and incident on the second light splitter 142 disposed at the intersection of the second main light path 112 and the second side light path 122. ½ of the third light rays 1331 incident on the second light splitter 142 are reflected to the light homogenizer 17, while the remaining ½ of the third light rays 1331 incident on the second light splitter 142 are transmitted through the second light splitter 142 to the reflectors 16 disposed at the intersection of the third main light path 113 and the second side light path 122, and the third light rays 1331 are reflected by the reflectors 16 from the second direction Y to the first direction X and then incident on the light homogenizer 17. Therefore, the first light rays 1311, the second light rays 1321, and the third light rays 1331 that are incident on the light homogenizer 17 are changed from one path to three paths, respectively, so that an area of the light paths that are incident on the light homogenizer 17 is expanded to realize the beam expansion. Further, the light rays are subjected to secondary homogenization by the light homogenizer 17, so that the effect of homogenization of the exit light rays from the RGB three-color laser light source synthesis and beam splitting device 1 is improved by using the simple planar structure without adding the separate beam expander.

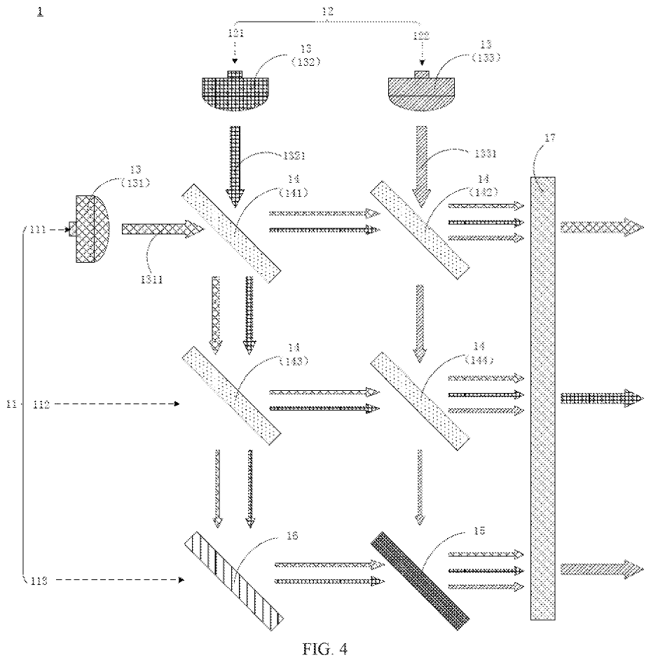

As shown in FIG. 4, in an embodiment of the present application, the main light paths 11 include a first main light path 111, a second main light path 112, and a third main light path 113, where the first main light path 111, the second main light path 112, and the third main light path 113 are disposed parallel to each other. The side light paths 12 include a first side light path 121 and a second side light path 122, where the second side light path 122 is disposed in parallel with the first side light path 121. The light splitters 14 include a first light splitter 141, a second light splitter 142, a third light splitter 143, and a fourth light splitter 144, where the first light splitter 141 is disposed at an intersection of the first main light path 111 and the first side light path 121 to transmit the portion of the first light rays 1311 and reflect the remaining portion of the first light rays 1311 to the second direction Y, and transmit the portion of the second light rays 1321 and reflect the remaining portion of the second light rays 1321 to the second direction Y; the second light splitter 142 is disposed at an intersection of the first main light path 111 and the second side light path 122 to transmit the first light rays 1311, the second light rays 1321, and the portion of the third light rays 1331, and reflect the remaining portion of the third light rays 1331 to the first direction X; the third light splitter 143 is disposed at an intersection of the second main light path 112 and the first side light path 121, to transmit the portion of the first light rays 1311 and reflect the remaining portion of the first light rays 1311 to the second direction Y, transmit the portion of the second light rays 1321 and reflect the remaining portion of the second light rays 1321 to the second direction Y; and the fourth light splitter 144 is disposed at an intersection of the second main light path 112 and the second side light path 122 to transmit the first light rays 1311, the second light rays 1321, and the portion of the third light rays 1331 and reflect the remaining portion of the third light rays 1331 to the first direction X. The reflectors 16 are disposed at an intersection of the third main light path 113 and the first side light path 121 to reflect the first light rays 1311 and the second light rays 1321 from the second direction Y to the first direction X. The light filters 15 are disposed at an intersection of the third main light path 113 and the second side light path 122 to transmit the first light rays 1311 and the second light rays 1321, and reflect the third light rays 1331 to the first direction X.

Specifically, the first light splitter 141 is configured to at least transmit ⅓ of the first light rays 1311 and reflect ⅔ of the first light rays 1311, and transmit ⅔ of the second light rays 1321 and reflect ⅓ of the second light rays 1321. The second light splitter 142 is configured to transmit the first light rays 1311, the second light rays 1321, and ⅔ of the third light rays 1331 and reflect ⅓ of the third light rays 1331. The third light splitter 143 is configured to at least transmit ½ of the first light rays 1311 and reflect ½ of the first light rays 1311, and transmit ½ of the second light rays 1321 and reflect ½ of the second light rays 1321. The fourth light splitter 144 is configured to transmit the first light rays 1311, the second light rays 1321, and ½ of the third light rays 1331 and reflect ½ of the third light rays 1331. The reflectors 16 are configured to at least reflect the first light rays 1311 and the second light rays 1321. The light filters 15 are configured to transmit the first light rays 1311, the second light rays 1321, and reflect the third light rays 1331.

That is, ⅓ of the first light rays 1311 emitted by the first light sources 131 in the first direction X are transmitted through the first light splitter 141 disposed at the intersection of the first main light path 111 and the first side light path 121 and the first light rays 1311 transmitted through the first light splitter 141 are all transmitted through the second light splitter 142 disposed at the intersection of the first main light path 111 and the second side light path 122 and incident on the light homogenizer 17, while the remaining ⅔ of the first light rays 1311 are reflected by the first light splitter 141 to the third light splitter 143 disposed at the intersection of the second main light path 112 and the first side light path 121. ½ of the first light rays 1311 incident on the third light splitter 143 are reflected to the first direction X and then all transmitted through the fourth light splitter 144 disposed at the intersection of the second main light path 112 and the second side light path 122 to the light homogenizer 17, while the remaining ½ of the first light rays 1311 incident on the third light splitter 143 are all transmitted through the third light splitter 143 to the reflectors 16 disposed at the intersection of the third main light path 113 and the first side light path 121, and the first light rays 1311 are reflected by the reflectors 16 from the second direction Y to the first direction X and then all transmitted through the light filters 15 disposed at the intersection of the third main light path 113 and the second side light path 122 to the light homogenizer 17. ⅓ of the second light rays 1321 emitted by the second light source 132 in the second direction Y are reflected by the first light splitter 141 disposed at the intersection of the first main light path 111 and the first side light path 121 to the second light splitter 142 disposed at the intersection of the first main light path 111 and the second side light path 122 and then all transmitted through the second light splitter 142 to the light homogenizer 17, while the remaining ⅔ of the second light rays 1321 are transmitted through the first light splitter 141 to the third light splitter 143 disposed at the intersection of the second main light path 112 and the first side light path 121. ½ of the second light rays 1321 incident on the third light splitter 143 are reflected to the first direction X and then all transmitted through the fourth light splitter 144 disposed at the intersection of the second main light path 112 and the second side light path 122 to the light homogenizer 17, while the remaining ½ of the second light rays 1321 incident on the third light splitter 143 are all transmitted through the third light splitter 143 to the reflectors 16 disposed at the intersection of the third main light path 113 and the first side light path 121, and the second light rays 1321 are all reflected by the reflectors 16 from the second direction Y to the first direction X and then transmitted through the light filters 15 disposed at the intersection of the third main light path 113 and the second side light path 122 to the light homogenizer 17. ⅓ of the third light rays 1331 emitted by the third light source 133 in the second direction Y are reflected by the second light splitter 142 disposed at the intersection of the first main light path 111 and the second side light path 122 to the first direction X and then incident on the light homogenizer 17, while the remaining ⅔ of the third light rays 1331 are transmitted through the second light splitter 142 and incident on the fourth light splitter 144 disposed at the intersection of the second main light path 112 and the second side light path 122. ½ of the third light rays 1331 incident on the fourth light splitter 144 are reflected to the light homogenizer 17, while the remaining ½ of the third light rays 1331 incident on the fourth light splitter 144 are transmitted through the fourth light splitter 144 to the light filters 15 disposed at the intersection of the third main light path 113 and the second side light path 122, and the third light rays 1331 are reflected by the light filters 15 from the second direction Y to the first direction X and then incident on the light homogenizer 17. Therefore, the first light rays 1311, the second light rays 1321, and the third light rays 1331 that are incident on the light homogenizer 17 are changed from one path to three paths, respectively, so that an area of the light paths that are incident on the light homogenizer 17 is expanded to realize the beam expansion. Further, the light rays are subjected to secondary homogenization by the light homogenizer 17, so that the effect of homogenization of the exit light rays from the RGB three-color laser light source synthesis and beam splitting device 1 is improved by using the simple planar structure without adding the separate beam expander.

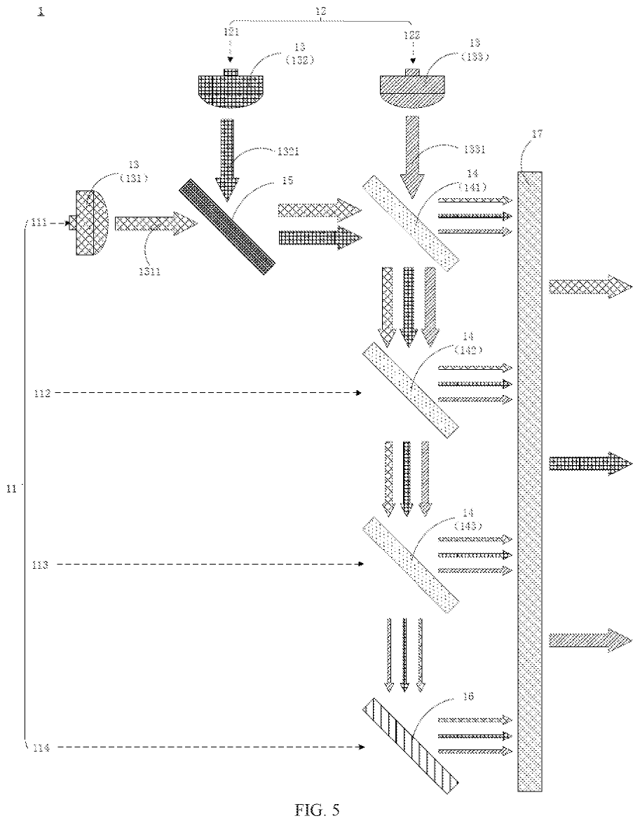

As shown in FIG. 5, in an embodiment of the present application, the main light paths 11 include a first main light path 111, a second main light path 112, a third main light path 113, and a fourth main light path 114, where the first main light path 111, the second main light path 112, the third main light path 113, and the fourth main light path 114 are disposed parallel to each other. The side light paths 12 include a first side light path 121 and a second side light path 122, where the second side light path 122 is disposed in parallel with the first side light path 121. The light filters 15 are disposed at an intersection of the first main light path 111 and the first side light path 121 to transmit the first light rays 1311 and reflect the second light rays 1321 to the first direction X. The light splitters 14 include a first light splitter 141, a second light splitter 142, and a third light splitter 143, where the first light splitter 141 is disposed at an intersection of the first main light path 111 and the second side light path 122 to transmit the portion of the first light rays 1311 and reflect the remaining portion of the first light rays 1311 to the second direction Y, transmit the portion of the second light rays 1321 and reflect the remaining portion of the second light rays 1321 to the second direction Y, and transmit the portion of the third light rays 1331 and reflect the remaining portion of the third light rays 1331 to the first direction X; the second light splitter 142 is disposed at an intersection of the second main light path 112 and the second side light path 122 to transmit the portion of the first light rays 1311 and reflect the remaining portion of the first light rays 1311 to the first direction X, transmit the portion of the second light rays 1321 and reflect the remaining portion of the second light rays 1321 to the first direction X, and transmit the portion of the third light rays 1331 and reflect the remaining portion of the third light rays 1331 to the first direction X; and the third light splitter 143 is disposed at an intersection of the third main light path 113 and the second side light path 122 to transmit the portion of the first light rays 1311 and reflect the remaining portion of the first light rays 1311 to the first direction X, transmit the portion of the second light rays 1321 and reflect the remaining portion of the second light rays 1321 to the first direction X, and transmit the portion of the third light rays 1331 and reflect the remaining portion of the third light rays 1331 to the first direction X. The reflectors 16 are disposed at an intersection of the fourth main light path 114 and the second side light path 122 to reflect the first light rays 1311, the second light rays 1321, and the third light rays 1331 from the second direction Y to the first direction X.

Specifically, the light filters 15 are configured to at least transmit the first light rays 1311 and reflect the second light rays 1321. The first light splitter 141 is configured to transmit ¼ of the first light rays 1311 and reflect ¾ of the first light rays 1311, transmit ¼ of the second light rays 1321 and reflect ¾ of the second light rays 1321, and transmit ¾ of the third light rays 1331 and reflect ¼ of the third light rays 1331. The second light-splitting 142 is configured to transmit ⅔ of the first light rays 1311 and reflect ⅓ of the first light rays 1311, transmit ⅔ of the second light rays 1321 and reflect ⅓ of the second light rays 1321, and transmit ⅔ of the third light rays 1331 and reflect ⅓ of the third light rays 1331. The third light splitter 143 is configured to transmit ½ of the first light rays 1311 and reflect ½ of the first light rays 1311, transmit ½ of the second light rays 1321 and reflect ½ of the second light rays 1321, and transmit ½ of the third light rays 1331 and reflect ½ of the third light rays 1331. The reflectors 16 are configured to reflect the first light rays 1311, the second light rays 1321, and the third light rays 1331.

That is, the first light rays 1311 emitted by the first light sources 131 in the first direction X are all transmitted through the light filters 15 disposed at the intersection of the first main light path 111 and the first side light path 121. Then, ¼ of the first light rays 1311 are transmitted through the first light splitter 141 disposed at the intersection of the first main light path 111 and the second side light path 122 and incident on the light homogenizer 17, while the remaining ¾ of the first light rays 1311 are reflected by the first light splitter 141 to the second light splitter 142 disposed at the intersection of the second main light path 112 and the second side light path 122. ⅓ of the first light rays 1311 incident on the second light splitter 142 are reflected to the light homogenizer 17, while the remaining ⅔ of the first light rays 1311 incident on the second light splitter 142 are transmitted through the second light splitter 142 to the third light splitter 143 disposed at the intersection of the third main light path 113 and the second side light path 122. ½ of the first light rays 1311 incident on the third light splitter 143 are reflected to the light homogenizer 17, while the remaining ½ of the first light rays 1311 incident on the third light splitter 143 are transmitted through the third light splitter 143 to the reflectors 16 disposed at the intersection of the fourth main light path 114 and the second side light path 122, and the first light rays 1311 are reflected by the reflectors 16 from the second direction Y to the first direction X and then incident on the light homogenizer 17. The second light rays 1321 emitted by the second light source 132 in the second direction Y are all reflected by the light filters 15 disposed at the intersection of the first main light path 111 and the first side light path 121 to the first direction X. Then, ¼ of the second light rays 1321 are transmitted through the first light splitter 141 disposed at the intersection of the first main light path 111 and the second side light path 122 and incident on the light homogenizer 17, while the remaining ¾ of the second light rays 1321 are reflected by the first light splitter 141 to the second light splitter 142 disposed at the intersection of the second main light path 112 and the second side light path 122. ⅓ of the second light rays 1321 incident on the second light splitter 142 are reflected to the light homogenizer 17, while the remaining ⅔ of the second light rays 1321 incident on the second light splitter 142 are transmitted through the second light splitter 142 to the third light splitter 143 disposed at the intersection of the third main light path 113 and the second side light path 122. ½ of the second light rays 1321 incident on the third light splitter 143 are reflected to the light homogenizer 17, while the remaining ½ of the second light rays 1321 incident on the third light splitter 143 are transmitted through the third light splitter 143 to the reflectors 16 disposed at the intersection of the fourth main light path 114 and the second side light path 122, and the second light rays 1321 are reflected by the reflectors 16 from the second direction Y to the first direction X and then incident on the light homogenizer 17. ¼ of the third light rays 1331 emitted by the third light source 133 in the second direction Y are reflected by the first light splitter 141 disposed at the intersection of the first main light path 111 and the second side light path 122 to the first direction X and then incident on the light homogenizer 17, while the remaining ¾ of the third light rays 1331 are transmitted through the first light splitter 141 and incident on the second light splitter 142 disposed at the intersection of the second main light path 112 and the second side light path 122. ⅓ of the third light rays 1331 incident on the second light splitter 142 are reflected to the light homogenizer 17, while the remaining ⅔ of the third light rays 1331 incident on the second light splitter 142 are transmitted through the second light splitter 142 to the third light splitter 143 disposed at the intersection of the third main light path 113 and the second side light path 122. ½ of the third light rays 1331 incident on the third light splitter 143 are reflected to the light homogenizer 17, while the remaining ½ of the third light rays 1331 incident on the third light splitter 143 are transmitted through the third light splitter 143 to the reflectors 16 disposed at the intersection of the fourth main light path 114 and the second side light path 122, and the third light rays 1331 are reflected by the reflectors 16 from the second direction Y to the first direction X and then incident on the light homogenizer 17. Therefore, the first light rays 1311, the second light rays 1321, and the third light rays 1331 that are incident on the light homogenizer 17 are changed from one path to four paths, respectively, so that an area of the light paths that are incident on the light homogenizer 17 is expanded to realize the beam expansion. Further, the light rays are subjected to secondary homogenization by the light homogenizer 17, so that the effect of homogenization of the exit light rays from the RGB three-color laser light source synthesis and beam splitting device 1 is improved by using the simple planar structure without adding the separate beam expander.

The light splitters 14, the light filters 15, and the reflectors 16 are used in combination in the present application to perform multi-pass reflection and splitting on the light rays emitted from the light source assembly 13, so that multiple light rays are generated on the main light paths 11 to realize the beam expansion. The first light rays 1311, the second light rays 1321, and the third light rays 1331 subjected to the beam expansion can be uniformly incident on the light homogenizer 17, and be subjected to secondary homogenization by the light homogenizer 17. The effect of homogenization of the exit light rays from the RGB three-color laser light source synthesis and beam splitting device 1 is improved by using the simple planar structure without adding the separate beam expander. It should be emphasized that the combination of the light splitters 14, the light filters 15, and the reflectors 16 has a large number of specific solutions and is not limited to the above-mentioned embodiments, and will not be repeatedly described in detail in the present application.

In summary, the present application provides the RGB three-color laser light source synthesis and beam splitting device 1, having the main light paths 11 extending in the first direction X and the side light paths 12 extending in the second direction Y perpendicular to the first direction X. The RGB three-color laser light source synthesis and beam splitting device 1 includes: the light source assembly 13 including the first light sources 131, the second light source 132, and the third light source 133, where the first light sources 131 are disposed in the main light paths 11 to emit the first light rays 1311 in the first direction X, the second light source 132 is disposed in the side light paths 12 to emit the second light rays 1321 in the second direction Y, and the third light source 133 is disposed in the side light paths 12 to emit the third light rays 1331 in the second direction Y; the light splitters 14 capable of transmitting the portion of the first light rays 1311, the portion of the second light rays 1321, and the portion of the third light rays 1331, and reflecting the remaining portion of the first light rays 1311, the remaining portion of the second light rays 1321, and the remaining portion of the third light rays 1331; the light filters 15 capable of transmitting one or two of the first light rays 1311, the second light rays 1321, and the third light rays 1331 and reflecting remainder of the first light rays 1311, the second light rays 1321, or the third light rays 1331; the reflectors 16 capable of reflecting the first light rays 1311, the second light rays 1321, and the third light rays 1331; and the light homogenizer 17 capable of uniformly emit the first light rays 1311, the second light rays 1321, and the third light rays 1331; where the light splitters 14, and the light filters 15, and/or the reflectors 16 can be capable of conducting the first light rays 1311, the second light rays 1321, and the third light rays 1331 to the light homogenizer 17, and the light homogenizer 17 can enable the first light rays 1311, the second light rays 1321, and the third light rays 1331 to be uniformly emitted from the first direction X. The light splitters 14, the light filters 15, and the reflectors 16 are used in combination in the RGB three-color laser light source synthesis and beam splitting device 1 of the present application to perform multi-pass reflection and splitting on the light rays emitted from the light source assembly 13, so that multiple light rays are generated on the main light paths 11 to realize the beam expansion. The first light rays 1311, the second light rays 1321, and the third light rays 1331 subjected to the beam expansion can be uniformly incident on the light homogenizer 17, and be subjected to secondary homogenization by the light homogenizer 17. The effect of homogenization of the exit light rays from the RGB three-color laser light source synthesis and beam splitting device 1 is improved by using the simple planar structure without adding the separate beam expander.

An embodiment that the RGB three-color laser light source synthesis and beam splitting device 1 includes the light filters 15 but does not include the reflectors 16 is introduced below.

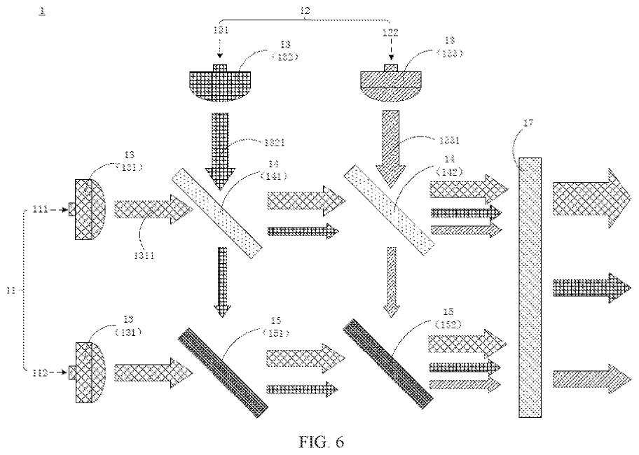

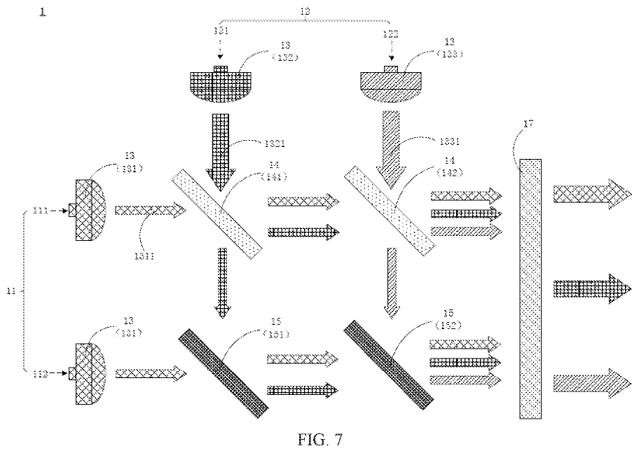

Referring to FIGS. 6 to 7, the present application provides an RGB three-color laser light source synthesis and beam splitting device 1, having main light paths 11 extending in a first direction X and side light paths 12 extending in a second direction Y perpendicular to the first direction X. The RGB three-color laser light source synthesis and beam splitting device 1 includes: a light source assembly 13 including first light sources 131, a second light source 132, and a third light source 133, where the first light sources 131 are disposed in the main light paths 11 to emit first light rays 1311 in the first direction X, the second light source 132 is disposed in the side light paths 12 to emit second light rays 1321 in the second direction Y, and the third light source 133 is disposed in the side light paths 12 to emit third light rays 1331 in the second direction Y; light splitters 14 capable of transmitting a portion of the first light rays 1311, a portion of the second light rays 1321, and a portion of the third light rays 1331, and reflecting remaining portion of the first light rays 1311, remaining portion of the second light rays 1321, and remaining portion of the third light rays 1331; light filters 15 capable of transmitting one or two of the first light rays 1311, the second light rays 1321, and the third light rays 1331 and reflecting remainder of the first light rays 1311, the second light rays 1321, or the third light rays 1331; and a light homogenizer 17 capable of uniformly emit the first light rays 1311, the second light rays 1321, and the third light rays 1331; where the light splitters 14 and the light filters 15 can be capable of conducting the first light rays 1311, the second light rays 1321, and the third light rays 1331 to the light homogenizer 17, and the light homogenizer 17 can enable the first light rays 1311, the second light rays 1321, and the third light rays 1331 to be uniformly emitted from the first direction X. The light splitters 14 and the light filters 15 are used in combination in the RGB three-color laser light source synthesis and beam splitting device 1 of the present application to perform multi-pass reflection and splitting on the light rays emitted from the light source assembly 13, so that multiple light rays are generated on the main light paths 11 to realize the beam expansion. The first light rays 1311, the second light rays 1321, and the third light rays 1331 subjected to the beam expansion can be uniformly incident on the light homogenizer 17, and be subjected to secondary homogenization by the light homogenizer 17. The effect of homogenization of the exit light rays from the RGB three-color laser light source synthesis and beam splitting device 1 is improved by using the simple planar structure without adding the separate beam expander.

As shown in FIGS. 6-7, in an embodiment of the present application, the main light paths 11 include a first main light path 111 and a second main light path 112, where the second main light path 112 is disposed in parallel with the first main light path 111. The side light paths 12 include a first side light path 121 and a second side light path 122, where the second side light path 122 is disposed in parallel with the first side light path 121. The first light sources 131 are disposed in the first main light path 111 and the second main light path 112, respectively. The second light source 132 is disposed in the first side light path 121. The third light source 133 is disposed in the second side light path 122. The light splitters 14 include a first light splitter 141 and a second light splitter 142, where the first light splitter 141 is disposed at an intersection of the first main light path 111 and the first side light path 121 to transmit the first light rays 1311 and the portion of the second light rays 1321 and reflect the remaining portion of the second light rays 1321 to the second direction Y. The second light splitter 142 is disposed at an intersection of the first main light path 111 and the second side light path 122 to transmit the first light rays 1311, the second light rays 1321, and the portion of the third light rays 1331, and reflect the remaining portion of the third light rays 1331 to the first direction X. The light filters 15 include a first light filter 151 and a second light filter 152, where the first light filter 151 is disposed at an intersection of the second main light path 112 and the first side light path 121 to transmit the first light rays 1311 and reflect the second light rays 1321 to the first direction X, and the second light filter 152 is disposed at an intersection of the second main light path 112 and the second side light path 122 to transmit the first light rays 1311 and the second light rays 1321, and reflect the third light rays 1331 to the first direction X.

Specifically, the first light splitter 141 is configured to at least transmit the first light rays 1311 and ½ of the second light rays 1321 and reflect ½ of the second light rays 1321. The second light splitter 142 is configured to transmit the first light rays 1311, the second light rays 1321, and ½ of the third light rays 1331 and reflect ½ of the third light rays 1331. The first light filter 151 is configured to at least transmit the first light rays 1311 and the second light rays 1321. The second light filter 152 is configured to transmit the first light rays 1311 and the second light rays 1321, and reflect the third light rays 1331.

That is, the first light rays 1311 emitted by the first light source 131 disposed in the first main light path 111 in the first direction X are all transmitted through the first light splitter 141 disposed at the intersection of the first main light path 111 and the first side light path 121 to the second light splitter 142 disposed at the intersection of the first main light path 111 and the second side light path 122, and then all transmitted through the second light splitter 142 to the light homogenizer 17. The first light rays 1311 emitted by the first light source 131 disposed in the second main light path 112 in the first direction X are all transmitted through the first light filter 151 disposed at the intersection of the second main light path 112 and the first side light path 121 to the second light filter 152 disposed at the intersection of the second main light path 112 and the second side light path 122, and then all transmitted through the second light filter 152 to the light homogenizer 17. ½ of the second light rays 1321 emitted by the second light source 132 disposed in the first side light path 121 in the second direction Y are reflected by the first light splitter 141 disposed at the intersection of the first main light path 111 and the first side light path 121 to the second light splitter 142 disposed at the intersection of the first main light path 111 and the second side light path 122, and then all transmitted through the second light splitter 142 to the light homogenizer 17, while the remaining ½ of the second light rays 1321 emitted by the second light source 132 disposed in the first side light path 121 in the second direction Y are transmitted through the first light splitter 141 to the first light filter 151 disposed at the intersection of the second main light path 112 and the first side light path 121, and then reflected by the first light filter 151 to the second light filter 152 disposed at the intersection of the second main light path 112 and the second side light path 122 and all transmitted through the second light filter 152 to the light homogenizer 17. ½ of the third light rays 1331 emitted by the third light source 133 in the second direction Y are reflected by the second light splitter 142 disposed at the intersection of the first main light path 111 and the second side light path 122 to the first direction X and then incident on the light homogenizer 17, while the remaining ½ of the third light rays 1331 are transmitted through the second light splitter 142 and incident on the second light filter 152, and the third light rays 1331 are reflected by the second light filter 152 from the second direction Y to the first direction X and then incident on the light homogenizer 17. Therefore, the first light rays 1311, the second light rays 1321, and the third light rays 1331 that are incident on the light homogenizer 17 are changed from one path to two paths, respectively, so that an area of the light paths that are incident on the light homogenizer 17 is expanded to realize the beam expansion. Further, the light rays are subjected to secondary homogenization by the light homogenizer 17, so that the effect of homogenization of the exit light rays from the RGB three-color laser light source synthesis and beam splitting device 1 is improved by using the simple planar structure without adding the separate beam expander.

In the present embodiment, at least two cases are included. The first case is that the first light sources 131, the second light source 132, and the third light source 133 have the same luminous intensity, as shown in FIG. 6. That is, in the present embodiment, the first light sources 131 are disposed in the first main light path 111 and the second main light path 112, respectively, to increase the first light rays 1311 of a light emitting surface, so that the display range of the RGB three-color laser light source synthesis and beam splitting device 1 is improved when a beam of a specific color light needs to be increased in a specific scene. The second case is that the sum of the luminous brightness of the first light source 131 disposed in the first main light path 111 and the luminous brightness of the first light source 131 disposed in the second main light path 112 is the same as the luminous brightness of the second light source 132, and the same as the luminous brightness of the third light source 133, as shown in FIG. 7. That is, although a group of first light sources 131 is added in the present embodiment, it can be still maintained that the first light sources 131, the second light source 132, and the third light source 133 each have the same luminous brightness at the light emitting surfaces of the RGB three-color laser light source synthesis and beam splitting device 1. In a practical application, it is possible to increase the number of the second light sources 132 on the first side light path 121 and increase the number of the third light sources 133 on the second side light path 122.

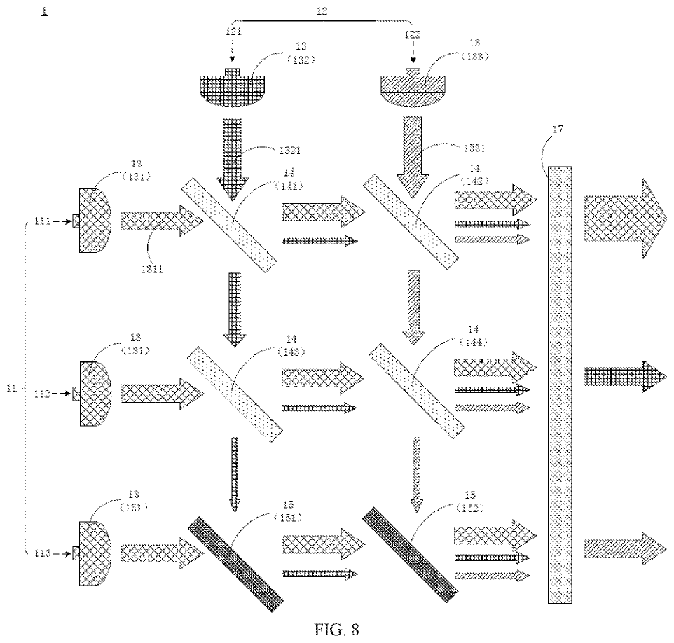

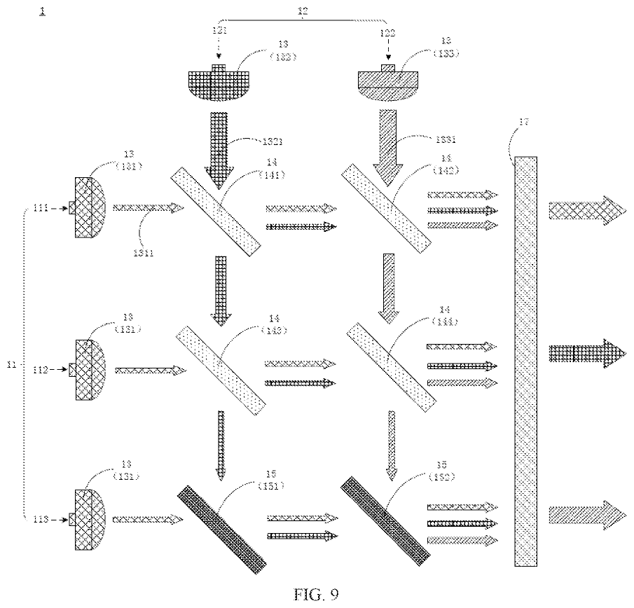

As shown in FIGS. 8-9, in an embodiment of the present application, the main light paths 11 include a first main light path 111, a second main light path 112, and a third main light path 113, where the first main light path 111, the second main light path 112, and the third main light path 113 are disposed parallel to each other. The side light paths 12 include a first side light path 121 and a second side light path 122, where the second side light path 122 is disposed in parallel with the first side light path 121. The first light sources 131 are disposed in the first main light path 111, the second main light path 112, and the third main light path 113, respectively. The second light source 132 is disposed in the first side light path 121. The third light source 133 is disposed in the second side light path 122. The light splitters include a first light splitter 141, a second light splitter 142, a third light splitter 143, and a fourth light splitter 144, where the first light splitter 141 is disposed at an intersection of the first main light path 111 and the first side light path 121 to transmit the first light rays 1311 and the portion of the second light rays 1321 and reflect the remaining portion of the second light rays 1321 to the second direction Y; the second light splitter 142 is disposed at an intersection of the first main light path 111 and the second side light path 122 to transmit the first light rays 1311, the second light rays 1321, and the portion of the third light rays 1331, and reflect the remaining portion of the third light rays 1331 to the first direction X; the third light splitter 143 is disposed at an intersection of the second main light path 112 and the first side light path 121, to transmit the first light rays 1311 and the portion of the second light rays 1321 and reflect the remaining portion of the second light rays 1321 to the second direction Y; and the fourth light splitter 144 is disposed at an intersection of the second main light path 112 and the second side light path 122 to transmit the first light rays 1311, the second light rays 1321, and the portion of the third light rays 1331 and reflect the remaining portion of the third light rays 1331 to the first direction X. The light filters 15 include a first light filter 151 and a second light filter 152, where the first light filter 151 is disposed at an intersection of the third main light path 113 and the first side light path 121 to transmit the first light rays 1311 and reflect the second light rays 1321 to the first direction X; and the second light filter 152 is disposed at an intersection of the third main light path 113 and the second side light path 122 to transmit the first light rays 1311 and the second light rays 1321, and reflect the third light rays 1331 to the first direction X.

Specifically, the first light splitter 141 is configured to at least transmit the first light rays 1311 and ⅓ of the second light rays 1321, and reflect ⅔ of the second light rays 1321. The second light splitter 142 is configured to transmit the first light rays 1311, the second light rays 1321, and ⅔ of the third light rays 1331 and reflect ⅓ of the third light rays 1331. The third light splitter 143 is configured to at least transmit the first light rays 1311 and ½ of the second light rays 1321 and reflect ½ of the second light rays 1321. The fourth light splitter 144 is configured to transmit the first light rays 1311, the second light rays 1321, and ½ of the third light rays 1331 and reflect ½ of the third light rays 1331. The first light filter 151 is configured to at least transmit the first light rays 1311 and reflect the second light rays 1321. The second light filter 152 is configured to transmit the first light rays 1311 and the second light rays 1321, and reflect the third light rays 1331.

That is, the first light rays 1311 emitted by the first light source 131 disposed in the first main light path 111 in the first direction X are all transmitted through the first light splitter 141 disposed at the intersection of the first main light path 111 and the first side light path 121 to the second light splitter 142 disposed at the intersection of the first main light path 111 and the second side light path 122, and then all transmitted through the second light splitter 142 to the light homogenizer 17. The first light rays 1311 emitted by the first light source 131 disposed in the second main light path 112 in the first direction X are all transmitted through the third light splitter 143 disposed at the intersection of the second main light path 112 and the first side light path 121 to the fourth light splitter 144 disposed at the intersection of the second main light path 112 and the second side light path 122, and then all transmitted through the fourth light splitter 144 to the light homogenizer 17. The first light rays 1311 emitted by the first light source 131 disposed in the third main light path 113 in the first direction X are all transmitted through the first light filter 151 disposed at the intersection of the third main light path 113 and the first side light path 121 to the second light filter 152 disposed at the intersection of the third main light path 113 and the second side light path 122, and then all transmitted through the second light filter 152 to the light homogenizer 17. ⅓ of the second light rays 1321 emitted by the second light source 132 disposed in the first side light path 121 in the second direction Y are reflected by the first light splitter 141 disposed at the intersection of the first main light path 111 and the first side light path 121 to the second light splitter 142 disposed at the intersection of the first main light path 111 and the second side light path 122, and then all transmitted through the second light splitter 142 to the light homogenizer 17, while the remaining ⅔ of the second light rays 1321 emitted by the second light source 132 on the first side light path 121 in the second direction Y are transmitted through the first light splitter 141 to the third light splitter 143 disposed at the intersection of the second main light path 112 and the first side light path 121. Then, ½ of the second light rays 1321 incident on the third light splitter 143 are reflected by the third light splitter 143 to the fourth light splitter 144 disposed at the intersection of the second main light path 112 and the second side light path 122 and then all transmitted through the fourth light splitter 144 to the light homogenizer 17, while the remaining ½ of the second light rays 1321 incident on the third light splitter 143 are transmitted through the third light splitter 143 to the first light filter 151 disposed at the intersection of the third main light path 113 and the first side light path 121 and then reflected by the first light filter 151 to the second light filter 152 disposed at the intersection of the third main light path 113 and the second side light path 122, and then all transmitted through the second light filter 152 to the light homogenizer 17. ⅓ of the third light rays 1331 emitted by the third light source 133 in the second direction Y are reflected by the second light splitter 142 disposed at the intersection of the first main light path 111 and the second side light path 122 to the first direction X and then incident on the light homogenizer 17, while the remaining ⅔ of the third light rays 1331 emitted by the third light source 133 in the second direction Y are transmitted through the second light splitter 142 and incident on the fourth light splitter 144 disposed at the intersection of the second main light path 112 and the second side light path 122. Then, ½ of the third light rays 1331 incident on the fourth light splitter 144 are reflected by the fourth light splitter 144 to the first direction X and then incident on the light homogenizer 17, while the remaining ½ of the third light rays 1331 injection into the fourth light splitter 144 are transmitted through the fourth light splitter 144 to the second light filter 152 disposed at the intersection of the third main light path 113 and the second side light path 122, and the third light rays 1331 are reflected by the second light filter 152 from the second direction Y to the first direction X and then incident on the light homogenizer 17. Therefore, the first light rays 1311, the second light rays 1321, and the third light rays 1331 that are incident on the light homogenizer 17 are changed from one path to three paths, respectively, so that an area of the light paths that are incident on the light homogenizer 17 is expanded to realize the beam expansion. Further, the light rays are subjected to secondary homogenization by the light homogenizer 17, so that the effect of homogenization of the exit light rays from the RGB three-color laser light source synthesis and beam splitting device 1 is improved by using the simple planar structure without adding the separate beam expander.

In the present embodiment, at least two cases are included. The first case is that the first light sources 131, the second light source 132, and the third light source 133 have the same luminous intensity, as shown in FIG. 6. That is, in the present embodiment, the first light sources 131 are disposed in the first main light path 111 and the second main light path 112, respectively, to increase the first light rays 1311 of a light emitting surface, so that the display range of the RGB three-color laser light source synthesis and beam splitting device 1 is improved when a beam of a specific color light needs to be increased in a specific scene. The second case is that the sum of the luminous brightness of the first light source 131 disposed in the first main light path 111, the luminous brightness of the first light source 131 disposed in the second main light path 112, and the luminous brightness of the first light source 131 disposed in the third main light path 113 is the same as the luminous brightness of the second light source 132 and the same as the luminous brightness of the third light source 133. That is, although two group of first light sources 131 are added in the present embodiment, it can be still maintained that the first light sources 131, the second light source 132, and the third light source 133 each have the same luminous brightness at the light emitting surfaces of the RGB three-color laser light source synthesis and beam splitting device 1. In a practical application, it is possible to increase the number of the second light sources 132 on the first side light path 121 and increase the number of the third light sources 133 on the second side light path 122.

The light splitters 14 and the light filters 15 are used in combination in the present application to perform multi-pass reflection and splitting on the light rays emitted from the light source assembly 13, so that multiple light rays are generated on the main light paths 11 to realize the beam expansion. The first light rays 1311, the second light rays 1321, and the third light rays 1331 subjected to the beam expansion can be uniformly incident on the light homogenizer 17, and be subjected to secondary homogenization by the light homogenizer 17. The effect of homogenization of the exit light rays from the RGB three-color laser light source synthesis and beam splitting device 1 is improved by using the simple planar structure without adding the separate beam expander. It should be emphasized that the combination of the light splitters 14 and the light filters 15 has a large number of specific solutions and is not limited to the above-mentioned embodiments, and will not be repeatedly described in detail in the present application.

In summary, the present application provides the RGB three-color laser light source synthesis and beam splitting device 1, having the main light paths 11 extending in the first direction X and the side light paths 12 extending in the second direction Y perpendicular to the first direction X. The RGB three-color laser light source synthesis and beam splitting device 1 includes: the light source assembly 13 including the first light sources 131, the second light source 132, and the third light source 133, where the first light sources 131 are disposed in the main light paths 11 to emit the first light rays 1311 in the first direction X, the second light source 132 is disposed in the side light paths 12 to emit the second light rays 1321 in the second direction Y, and the third light source 133 is disposed in the side light paths 12 to emit the third light rays 1331 in the second direction Y; the light splitters 14 capable of transmitting the portion of the first light rays 1311, the portion of the second light rays 1321, and the portion of the third light rays 1331, and reflecting the remaining portion of the first light rays 1311, the remaining portion of the second light rays 1321, and the remaining portion of the third light rays 1331; the light filters 15 capable of transmitting one or two of the first light rays 1311, the second light rays 1321, and the third light rays 1331 and reflecting remainder of the first light rays 1311, the second light rays 1321, or the third light rays 1331; and the light homogenizer 17 capable of uniformly emit the first light rays 1311, the second light rays 1321, and the third light rays 1331; where the light splitters 14, and the light filters 15, and the first light rays 1311 can be capable of conducting the first light rays 1311, the second light rays 1321, and the third light rays 1331 to the light homogenizer 17, and the light homogenizer 17 can enable the second light rays 1321, and the third light rays 1331 to be uniformly emitted from the first direction X. The light splitters 14 and the light filters 15 are used in combination in the RGB three-color laser light source synthesis and beam splitting device 1 of the present application to perform multi-pass reflection and splitting on the light rays emitted from the light source assembly 13, so that multiple light rays are generated on the main light paths 11 to realize the beam expansion. The first light rays 1311, the second light rays 1321, and the third light rays 1331 subjected to the beam expansion can be uniformly incident on the light homogenizer 17, and be subjected to secondary homogenization by the light homogenizer 17. The effect of homogenization of the exit light rays from the RGB three-color laser light source synthesis and beam splitting device 1 is improved by using the simple planar structure without adding the separate beam expander.

An embodiment that the RGB three-color laser light source synthesis and beam splitting device 1 includes the reflectors 16 but does not include the light filters 15 is introduced below.

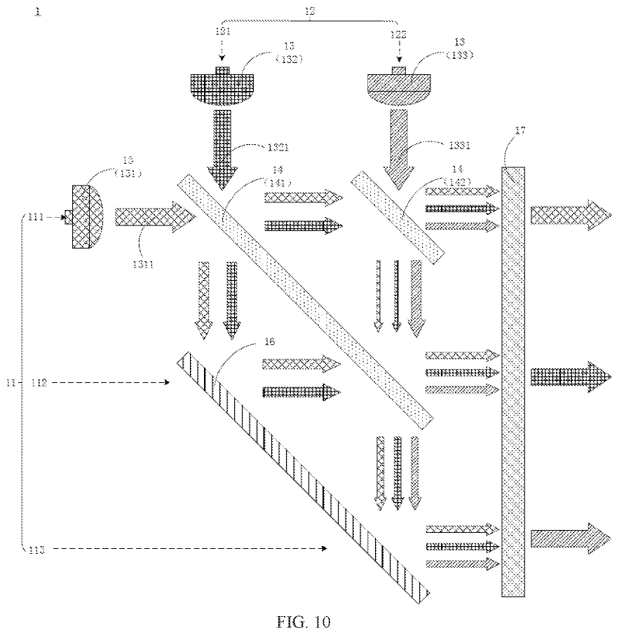

Referring to FIGS. 10 to 12, the present application provides an RGB three-color laser light source synthesis and beam splitting device 1, having main light paths 11 extending in a first direction X and side light paths 12 extending in a second direction Y perpendicular to the first direction X. The RGB three-color laser light source synthesis and beam splitting device 1 includes: a light source assembly 13 including first light sources 131, a second light source 132, and a third light source 133, where the first light sources 131 are disposed in the main light paths 11 to emit first light rays 1311 in the first direction X, the second light source 132 is disposed in the side light paths 12 to emit second light rays 1321 in the second direction Y, and the third light source 133 is disposed in the side light paths 12 to emit third light rays 1331 in the second direction Y; light splitters 14 capable of transmitting a portion of the first light rays 1311, a portion of the second light rays 1321, and a portion of the third light rays 1331, and reflecting remaining portion of the first light rays 1311, remaining portion of the second light rays 1321, and remaining portion of the third light rays 1331; reflectors 16 capable of reflecting the first light rays 1311, the second light rays 1321, and the third light rays 1331; and a light homogenizer 17 capable of uniformly emit the first light rays 1311, the second light rays 1321, and the third light rays 1331; where the light splitters 14 and the reflectors 16 can be capable of conducting the first light rays 1311, the second light rays 1321, and the third light rays 1331 to the light homogenizer 17, and the light homogenizer 17 can enable the first light rays 1311, the second light rays 1321, and the third light rays 1331 to be uniformly emitted from the first direction X. The light splitters 14 and the reflectors 16 are used in combination in the RGB three-color laser light source synthesis and beam splitting device 1 of the present application to perform multi-pass reflection and splitting on the light rays emitted from the light source assembly 13, so that multiple light rays are generated on the main light paths 11 to realize the beam expansion. The first light rays 1311, the second light rays 1321, and the third light rays 1331 subjected to the beam expansion can be uniformly incident on the light homogenizer 17, and be subjected to secondary homogenization by the light homogenizer 17. The effect of homogenization of the exit light rays from the RGB three-color laser light source synthesis and beam splitting device 1 is improved by using the simple planar structure without adding the separate beam expander.

As shown in FIG. 1, in an embodiment of the present application, the main light paths 11 include a first main light path 111, a second main light path 112, and a third main light path 113, where the first main light path 111, the second main light path 112, and the third main light path 113 are arranged parallel to each other. The side light paths 12 include a first side light path 121 and a second side light path 122, where the second side light path 122 is disposed in parallel with the first side light path 121. The light splitters 14 include a first light splitter 141 and a second light splitter 142, where the first light splitter 141 is disposed at an intersection of the first main light path 111 and the first side light path 121 and extends to an intersection of the second main light path 112 and the second side light path 122 to transmit the portion of the first light rays 1311 and reflect the remaining portion of the first light rays 1311, transmit the portion of the second light rays 1321 and reflect the remaining portion of the second light rays 1321, and transmit the portion of the third light rays 1331 and reflect the remaining portion of the third light rays 1331. The second light splitter 142 is disposed at an intersection of the first main light path 111 and the second side light path 122 to transmit the first light rays 1311, the second light rays 1321, and the portion of the third light rays 1331, and reflect the remaining portion of the third light rays 1331 to the first direction X. The reflectors 16 are disposed at an intersection of the second main light path 112 and the first side light path 121 and extends to an intersection of the third main light path 113 and the second side light path 122 to reflect the first light rays 1311, the second light rays 1321, and the third light rays 1331 from the second direction Y to the first direction X.

Specifically, the first light splitter 141 is configured to transmit ½ of the first light rays 1311 and reflect ½ of the first light rays 1311, transmit ½ of the second light rays 1321 and reflect ½ of the second light rays 1321, and transmit ½ of the third light rays 1331 and reflect ½ of the third light rays 1331. The second light splitter 142 is configured to transmit ⅔ of the first light rays 1311 and reflect ⅓ of the first light rays 1311, transmit ⅔ of the second light rays 1321 and reflect ⅓ of the second light rays 1321, and transmit ⅔ of the third light rays 1331 and reflect ⅓ of the third light rays 1331. The reflectors 16 are configured to reflect the first light rays 1311, the second light rays 1321, and the third light rays 1331.

That is, ½ of the first light rays 1311 emitted by the first light source 131 in the first direction X are transmitted through the first light splitter 141 disposed at the intersection of the first main light path 111 and the first side light path 121, and ⅔ of the first light rays 1311 transmitted through the first light splitter 142 are transmitted through the second light splitter 142 disposed at the intersection of the first main light path 111 and the second side light path 122 and incident on the light homogenizer 17. The remaining ⅓ of the first light rays 1311 transmitted through the first light splitter 141 are reflected by the second light splitter 142 disposed at the intersection of the first main light path 111 and the second side light path 122 to the first light splitter 141 disposed at the intersection of the second main light path 112 and the second side light path 122. Then, ½ of the first light rays 1311 reflected by the second light splitter 142 are reflected by the first light splitter 141 disposed at the intersection of the second main light path 112 and the second side light path 122 to the light homogenizer 17, while the remaining ½ of the first light rays 1311 reflected by the second light splitter 142 are transmitted through the first light splitter 141 disposed at the intersection of the second main light path 112 and the second side light path 122 to the reflectors 16 disposed at the intersection of the third main light path 113 and the second side light path 122, and then the first light rays 1311 are all reflected by the reflectors 16 from the second direction Y to the first direction X. In addition, the remaining ½ of the first light rays 1311 emitted by the first light source 131 in the first direction X are reflected by the first light splitter 141 disposed at the intersection of the first main light path 111 and the first side light path 121 to the reflectors 16 disposed at the intersection of the second main light path 112 and the first side light path 121, and the first light rays 1311 are all reflected by the reflectors 16 from the second direction Y to the first light splitter 141 disposed at the intersection of the second main light path 112 and the second side light path 122. Then, ½ of the first light rays 1311 reflected by the reflectors 16 are transmitted through the first light splitter 141 disposed at the intersection of the second main light path 112 and the second side light path 122 and incident on the light homogenizer 17, while the remaining ½ of the first light rays 1311 reflected by the reflectors 16 are reflected by the first light splitter 141 disposed at the intersection of the second main light path 112 and the second side light path 122 to the reflectors 16 disposed at the intersection with the third main light path 113 and the second side light path 122, and the first light rays 1311 are all reflected by the reflectors 16 from the second direction Y to the first direction X and then incident on the light homogenizer 17. ½ of the second light rays 1321 emitted by the second light source 132 in the second direction Y are reflected by the first light splitter 141 disposed at the intersection of the first main light path 111 and the first side light path 121 to the second light splitter 142 disposed at the intersection of the first main light path 111 and the second side light path 122. Then, ⅔ of the second light rays 1321 reflected by the first light splitter 141 disposed at the intersection of the first main light path 111 and the first side light path 121 are transmitted through the second light splitter 142 disposed at the intersection of the first main light path 111 and the second side light path 122 and incident on the light homogenizer 17. The remaining ⅓ of the second light rays 1321 transmitted through the first light splitter 141 disposed at the intersection of the first main light path 111 and the first side light path 121 are reflected by the second light splitter 142 disposed at the intersection of the first main light path 111 and the second side light path 122 to the first light splitter 141 disposed at the intersection of the second main light path 112 and the second side light path 122. Then, ½ of the second light rays 1321 reflected by the second light splitter 142 are reflected by the first light splitter 141 disposed at the intersection of the second main light path 112 and the second side light path 122 to the light homogenizer 17, while the remaining ½ of the second light rays 1321 reflected by the second light splitter 142 are transmitted through the first light splitter 141 disposed at the intersection of the second main light path 112 and the second side light path 122 to the reflectors 16 disposed at the intersection of the third main light path 113 and the second side light path 122, and then the second light rays 1321 are all reflected by the reflectors 16 from the second direction Y to the first direction X. In addition, the remaining ½ of the second light rays 1321 emitted by the second light source 132 in the second direction Y are transmitted through the first light splitter 141 disposed at the intersection of the first main light path 111 and the first side light path 121 to the reflectors 16 disposed at the intersection of the second main light path 112 and the first side light path 121, and the second light rays 1321 are all reflected by the reflectors 16 from the second direction Y to the first light splitter 141 disposed at the intersection of the second main light path 112 and the second side light path 122. Then, ½ of the second light rays 1321 reflected by the reflectors 16 are transmitted through the first light splitter 141 disposed at the intersection of the second main light path 112 and the second side light path 122 and incident on the light homogenizer 17, while the remaining ½ of the second light rays 1321 reflected by the reflectors 16 are reflected by the first light splitter 141 disposed at the intersection of the second main light path 112 and the second side light path 122 to the reflectors 16 disposed at the intersection with the third main light path 113 and the second side light path 122, and the second light rays 1321 are all reflected by the reflectors 16 from the second direction Y to the first direction X and then incident on the light homogenizer 17. ⅓ of the third light rays 1331 emitted by the third light source 133 in the second direction Y are reflected by the second light splitter 142 disposed at the intersection of the first main light path 111 and the second side light path 122 to the first direction X and then incident on the light-equalizing element 17, while the remaining ⅔ of the third light rays 1331 are transmitted through the second light splitter 142 and incident on the first light splitter 141 disposed at the intersection of the second main light path 112 and the second side light path 122. ½ of the third light rays 1331 incident on the first light splitter 141 are reflected to the light-equalizing element 17, while the remaining ½ of the third light rays 1331 incident on the first light splitter 141 are transmitted through the first light splitter 141 to the reflectors 16 disposed at the intersection of the third main light path 113 and the second side light path 122, and the third light rays 1331 are reflected by the reflectors 16 from the second direction Y to the first direction X and then incident on the light homogenizer 17. Therefore, the first light rays 1311, the second light rays 1321, and the third light rays 1331 that are incident on the light homogenizer 17 are changed from one path to three paths, respectively, so that an area of the light paths that are incident on the light homogenizer 17 is expanded to realize the beam expansion. Further, the light rays are subjected to secondary homogenization by the light homogenizer 17, so that the effect of homogenization of the exit light rays from the RGB three-color laser light source synthesis and beam splitting device is improved by using the simple planar structure without adding the separate beam expander.

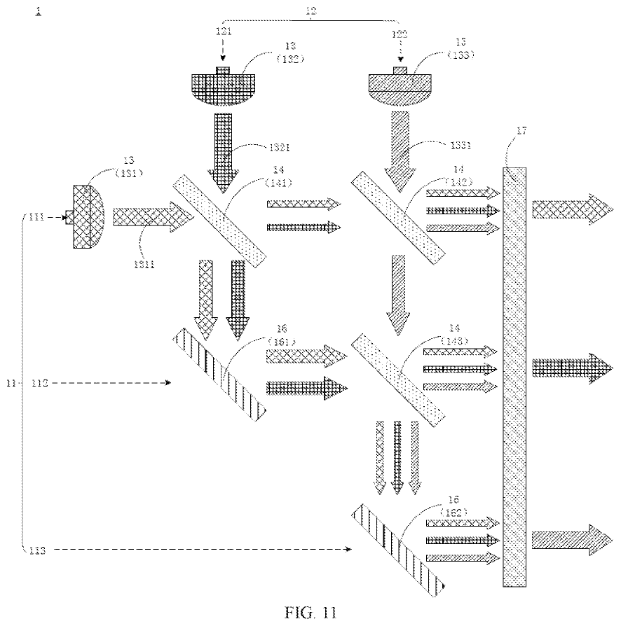

As shown in FIG. 11, in an embodiment of the present application, the main light paths 11 include a first main light path 111, a second main light path 112, and a third main light path 113, where the first main light path 111, the second main light path 112, and the third main light path 113 are disposed parallel to each other. The side light paths 12 include a first side light path 121 and a second side light path 122, where the second side light path 122 is disposed in parallel with the first side light path 121. The light splitters 14 include a first light splitter 141, a second light splitter 142, and a third light splitter 143, where the first light splitter 141 is disposed at the intersection of the first main light path 111 and the first side light path 121 to transmit the portion of the first light rays 1311 and reflect the remaining portion of the first light rays 1311 to the second direction Y, and transmit the portion of the second light rays 1321 and reflect the remaining portion of the second light rays 1321 to the second direction Y; the second light splitter 142 is disposed at an intersection of the first main light path 111 and the second side light path 122 to transmit the first light rays 1311, the second light rays 1321, and the portion of the third light rays 1331, and reflect the remaining portion of the third light rays 1331 to the first direction X; the third light splitter 143 is disposed at an intersection of the second main light path 112 and the second side light path 122, to transmit the portion of the first light rays 1311 and reflect the remaining portion of the first light rays 1311 to the second direction Y, transmit the portion of the second light rays 1321 and reflect the remaining portion of the second light rays 1321 to the second direction Y, and transmit the portion of the third light rays 1331 and reflect the remaining portion of the third light rays 1331 to the first direction X. The reflectors 16 include a first reflector 161 and a second reflector 162, where the first reflector 161 is disposed at an intersection of the second main light path 112 and the first side light path 121 to reflect the first light rays 1311 and the second light rays 1321 from the second direction Y to the first direction X. The second reflector 162 is disposed at an intersection of the third main light path 113 and the second side light path 122 to reflect the first light rays 1311, the second light rays 1321 and the third light rays 1331 from the second direction Y to the first direction X.

Specifically, the first light splitter 141 is configured to at least transmit ⅓ of the first light rays 1311 and reflect ⅔ of the first light rays 1311, and transmit ⅔ of the second light rays 1321 and reflect ⅓ of the second light rays 1321. The second light splitter 142 is configured to transmit the first light rays 1311, the second light rays 1321, and ⅔ of the third light rays 1331 and reflect ⅓ of the third light rays 1331. The third light splitter 143 is configured to at least transmit ½ of the first light rays 1311 and reflect ½ of the first light rays 1311, transmit ½ of the second light rays 1321 and reflect ½ of the second light rays 1321, and transmit ½ of the third light rays 1321 and reflect ½ of the third light rays 1321. The first reflector 161 is configured to at least reflect the first light rays 1311 and the second light rays 1321. The second reflector 162 is configured to reflect the first light rays 1311, the second light rays 1321, and the third light rays 1331.

That is, ⅓ of the first light rays 1311 emitted by the first light source 131 in the first direction X are transmitted through the first light splitter 141 disposed at the intersection of the first main light path 111 and the first side light path 121 and then the first light rays 1311 transmitted through the first light splitter 141 are all transmitted through the second light splitter 142 disposed at the intersection of the first main light path 111 and the second side light path 122 and incident on the light homogenizer 17. The remaining ⅔ of the first light rays 1311 emitted by the first light source 131 in the first direction X are reflected by the first light splitter 141 disposed at the intersection of the first main light path 111 and the first side light path 121 to the first reflector 161 disposed at the intersection of the second main light path 112 and the first side light path 121. ½ of the first light rays 1311 reflected by the first reflector 161 are transmitted through the third light splitter 143 disposed at the intersection of the second main light path 112 and the second side light path 122 to the light homogenizer 17. The remaining ½ of the first light rays 1311 reflected by the first reflector 161 are reflected by the third light splitter 143 disposed at the intersection of the second main light path 112 and the second side light path 122 to the second reflector 162 disposed at the intersection of the third main light path 113 and the second side light path 122, and the first light rays 1311 are all reflected by the second reflector 162 from the second direction Y to the first direction X and then incident on the light homogenizer 17. ⅓ of the second light rays 1321 emitted by the second light source 132 in the second direction Y are reflected by the first light splitter 141 disposed at the intersection of the first main light path 111 and the first side light path 121 to the second light splitter 142 disposed at the intersection of the first main light path 111 and the second side light path 122, and then are all transmitted through the second light splitter 142 and incident on the light homogenizer 17. The remaining ⅔ of the second light rays 1321 emitted by the second light source 132 in the second direction Y are transmitted through the first light splitter 141 disposed at the intersection of the first main light path 111 and the first side light path 121 to the first reflector 161 disposed at the intersection of the second main light path 112 and the first side light path 121. Then, ½ of the second light rays 1321 reflected by the first reflector 161 are transmitted through the third light splitter 143 disposed at the intersection of the second main light path 112 and the second side light path 122 to the light homogenizer 17. The remaining ½ of the second light rays 1321 reflected by the first reflector 161 are reflected by the third light splitter 143 disposed at the intersection of the second main light path 112 and the second side light path 122 to the second reflector 162 disposed at the intersection of the third main light path 113 and the second side light path 122, and the second light rays 1321 are all reflected by the second reflector 162 from the second direction Y to the first direction X and then incident on the light homogenizer 17. ⅓ of the third light rays 1331 emitted by the third light source 133 in the second direction Y are reflected by the second light splitter 142 disposed at the intersection of the first main light path 111 and the first side light path 122 to the first direction X and then incident on the light homogenizer 17, while the remaining ⅔ of the third light rays 1331 are transmitted through the second light splitter 142 and incident on the third light splitter 143 disposed at the intersection of the second main light path 112 and the second side light path 122. ½ of the third light rays 1331 incident on the third light splitter 143 is reflected to the light homogenizer 17, while the remaining ½ of the third light rays 1331 incident on the third light splitter 143 are transmitted through the third light splitter 143 to the second reflectors 162 disposed at the intersection of the third main light path 113 and the second side light path 122, and the third light rays 1331 are reflected by the second reflector 162 from the second direction Y to the first direction X and then incident on the light homogenizer 17. Therefore, the first light rays 1311, the second light rays 1321, and the third light rays 1331 that are incident on the light homogenizer 17 are changed from one path to three paths, respectively, so that an area of the light paths that are incident on the light homogenizer 17 is expanded to realize the beam expansion. Further, the light rays are subjected to secondary homogenization by the light homogenizer 17, so that the effect of homogenization of the exit light rays from the RGB three-color laser light source synthesis and beam splitting device is improved by using the simple planar structure without adding the separate beam expander.

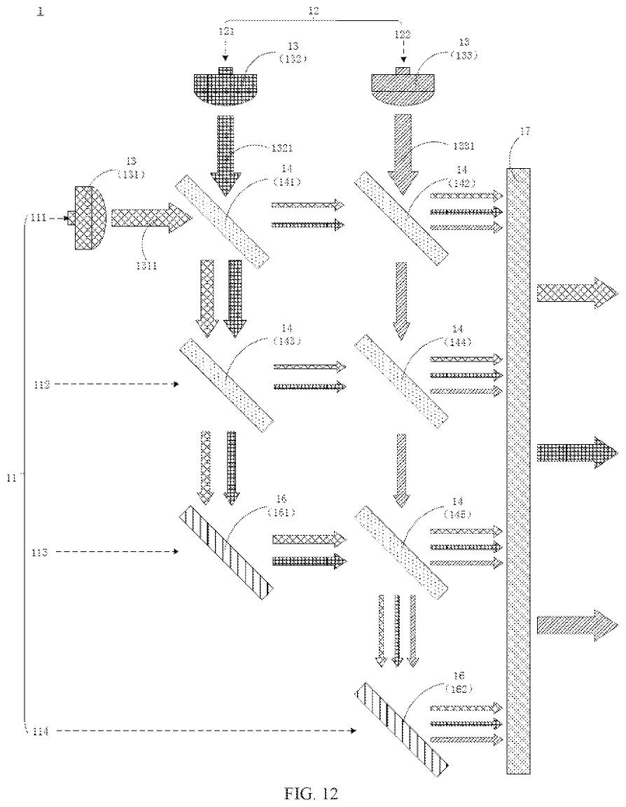

As shown in FIG. 12, in an embodiment of the present application, the main light paths 11 include a first main light path 111, a second main light path 112, a third main light path 113, and a fourth main light path 114, where the first main light path 111, the second main light path 112, the third main light path 113, and the fourth main light path 114 are disposed parallel to each other. The side light paths 12 include a first side light path 121 and a second side light path 122, where the second side light path 122 is disposed in parallel with the first side light path 121. The light splitters 14 include a first light splitter 141, a second light splitter 142, a third light splitter 143, a fourth light splitter 144, and a fifth light splitter 145, where the first light splitter 141 is disposed at an intersection of the first main light path 111 and the first side light path 121 to transmit the portion of the first light rays 1311 and reflect the remaining portion of the first light rays 1311 to the second direction Y, and transmit the portion of the second light rays 1321 and reflect the remaining portion of the second light rays 1321 to the second direction Y; the second light splitter 142 is disposed at an intersection of the first main light path 111 and the second side light path 122 to transmit the first light rays 1311, the second light rays 1321, and the portion of the third light rays 1331, and reflect the remaining portion of the third light rays 1331 to the first direction X; the third light splitter 143 is disposed at an intersection of the second main light path 112 and the second side light path 122, to transmit the portion of the first light rays 1311 and reflect the remaining portion of the first light rays 1311 to the second direction Y, transmit the portion of the second light rays 1321 and reflect the remaining portion of the second light rays 1321 to the second direction Y; the fourth light splitter 144 is disposed at an intersection of the second main light path 112 and the second side light path 122 to transmit the first light rays 1311, the second light rays 1321, and the portion of the third light rays 1331 and reflect the remaining portion of the third light rays 1331 to the first direction X; and the fifth light splitter 145 is disposed at an intersection of the second main light path 112 and the second side light path 122 to transmit the portion of the first light rays 1311 and reflect the remaining portion of the first light rays 1311 to the second direction Y, transmit the portion of the second light rays 1321 and reflect the remaining portion of the second light rays 1321 to the second direction Y, and transmit the portion of the third light rays 1331 and reflect the remaining portion of the third light rays 1331 to the first direction X. The reflectors 16 include a first reflector 161 and a second reflector 162, where the first reflector 161 is disposed at an intersection of the third main light path 113 and the first side light path 121 to reflect the first light rays 1311 and the second light rays 1321 from the second direction Y to the first direction X, and the second reflector 162 is disposed at an intersection of the fourth main light path 114 and the second side light path 122 to reflect the first light rays 1311, the second light rays 1321 and third light rays 1331 from the second direction Y to the first direction X.

Specifically, the first light splitter 141 is configured to at least transmit ¼ of the first light rays 1311 and reflect ¾ of the first light rays 1311, and transmit ¾ of the second light rays 1321 and reflect ¼ of the second light rays 1321. The second light splitter 142 is configured to transmit the first light rays 1311, the second light rays 1321, and ¾ of the third light rays 1331 and reflect ¼ of the third light rays 1331. The third light splitter 143 is configured to at least transmit ⅓ of the first light rays 1311 and reflect ⅔ of the first light rays 1311, and transmit ⅔ of the second light rays 1321 and reflect ⅓ of the second light rays 1321. The fourth light splitter 144 is configured to transmit the first light rays 1311, the second light rays 1321, and ⅔ of the third light rays 1331 and reflect ⅓ of the third light rays 1331. The fifth light splitter 145 is configured to at least transmit ½ of the first light rays 1311 and reflect ½ of the first light rays 1311, transmit ½ of the second light rays 1321 and reflect ½ of the second light rays 1321, and transmit ½ of the third light rays 1331 and reflect ½ of the third light rays 1331. The first reflector 161 is configured to at least reflect the first light rays 1311 and the second light rays 1321. The second reflector 162 is configured to reflect the first light rays 1311, the second light rays 1321, and the third light rays 1331.

That is, ¼ of the first light rays 1311 emitted by the first light source 131 in the first direction X are transmitted through the first light splitter 141 disposed at the intersection of the first main light path 111 and the first side light path 121, and the first light rays 1311 transmitted through the first light splitter 141 are all transmitted through the second light splitter 142 disposed at the intersection of the first main light path 111 and the second side light path 122 and incident on the light homogenizer 17. The remaining ¾ of the first light rays 1311 emitted by the first light source 131 in the first direction X are reflected by the first light splitter 141 disposed at the intersection of the first main light path 111 and the first side light path 121 to the third light splitter 143 disposed at the intersection of the second main light path 112 and the first side light path 121. Then, ⅓ of the first light rays 1311 reflected by the first light splitter 141 are reflected by the third light splitter 143 disposed at the intersection of the second main light path 112 and the first side light path 121 to the fourth light splitter 144 disposed at the intersection of the second main light path 112 and the second side light path 122, and then the first light rays 1311 reflected by the third light splitter 143 are all transmitted through the fourth light splitter 144 and incident on the light homogenizer 17. The remaining ⅔ of the first light rays 1311 reflected by the first light splitter 141 are transmitted through the third light splitter 143 disposed at the intersection of the second main light path 112 and the first side light path 121 to the first reflector 161 disposed at the intersection of the third main light path 113 and the second side light path 122, and are all reflected by the first reflector 16 to the fifth light splitter 145 disposed at the intersection of the third main light path 113 and the second side light path 122. ½ of the first light rays reflected by the first reflector 161 are transmitted through the fifth light splitter 145 and incident on the light homogenizer 17. The remaining ½ of the first light rays 1311 reflected by the first reflector 161 are reflected by the fifth light splitter 145 to the second reflector 162 disposed at the intersection of the fourth main light path 114 and the second side light path 122, and the first light rays 1311 are all reflected by the second reflector 162 from the second direction Y to the first direction X and then incident on the light homogenizer 17. ¼ of the second light rays 1321 emitted by the second light source 132 in the second direction Y are reflected by the first light splitter 141 disposed at the intersection of the first main light path 111 and the first side light path 121 to the second light splitter 142 disposed at the intersection of the first main light path 111 and the second side light path 122, and then all transmitted through the second light splitter 142 and incident on the light homogenizer 17. The remaining ¾ of the second light rays 1321 emitted by the second light source 132 in the second direction Y are transmitted through the first light splitter 141 disposed at the intersection of the first main light path 111 and the first side light path 121 to the third light splitter 143 disposed at the intersection of the second main light path 112 and the first side light path 121. Then, ⅓ of the second light rays 1321 transmitted through the first light splitter 141 are reflected by the third light splitter 143 disposed at the intersection of the second main light path 112 and the first side light path 121 to the fourth light splitter 144 disposed at the intersection of the second main light path 112 and the second side light path 122, and then the second light rays 1321 reflected by the third light splitter 143 are all transmitted through the fourth light splitter 144 and incident on the light homogenizer 17. The remaining ⅔ of the second light rays 1321 transmitted through the first light splitter 141 are transmitted through the third light splitter 143 disposed at the intersection of the second main light path 112 and the first side light path 121 to the first reflector 161 disposed at the intersection of the third main light path 113 and the first side light path 121, and are all reflected by the first reflector 161 to the fifth light splitter 145 disposed at the intersection of the third main light path 113 and the second side light path 122. ½ of the second light rays reflected by the first reflector 161 are transmitted through the fifth light splitter 145 and incident on the light homogenizer 17. The remaining ½ of the second light rays 1321 reflected by the first reflector 161 are reflected by the fifth light splitter 145 to the second reflector 162 disposed at the intersection with the fourth main light path 114 and the second side light path 122, and the second light rays 1321 are all reflected by the second reflector 162 from the second direction Y to the first direction X and then incident on the light homogenizer 17. ¼ of the third light rays 1331 emitted by the third light source 133 in the second direction Y are reflected by the second light splitter 142 disposed at the intersection of the first main light path 111 and the second side light path 122 to the first direction X and then incident on the light homogenizer 17, while remaining ¾ of the third light rays 1331 are transmitted through the second light splitter 142 and incident on the fourth light splitter 144 disposed at the intersection of the second main light path 112 and the second side light path 122. ⅓ of the third light rays 1331 incident on the fourth light splitter 144 are reflected to the light homogenizer 17, while the remaining ⅔ of the third light rays 1331 incident on the fourth light splitter 144 are transmitted through the fourth light splitter 144 to the fifth light splitter 145 disposed at the intersection of the third main light path 113 and the second side light path 122. ½ of the third light rays 1331 incident on the fifth light splitter 145 are reflected to the light homogenizer 17, while the remaining ½ of the third light rays 1331 incident on the fifth light splitter 145 are transmitted through the fifth light splitter 145 to the second reflector 162 disposed at the intersection of the fourth main light path 114 and the second side light path 122, and the third light rays 1331 are reflected by the second reflector 162 from the second direction Y to the first direction X and then incident on the light homogenizer 17. Therefore, the first light rays 1311, the second light rays 1321, and the third light rays 1331 that are incident on the light homogenizer 17 are changed from one path to four paths, respectively, so that an area of the light paths that are incident on the light homogenizer 17 is expanded to realize the beam expansion. Further, the light rays are subjected to secondary homogenization by the light homogenizer 17, so that the effect of homogenization of the exit light rays from the RGB three-color laser light source synthesis and beam splitting device is improved by using the simple planar structure without adding the separate beam expander.

It should be understood that the light splitters 14 and the reflectors 16 are used in combination in the present application to perform multi-pass reflection and splitting on the light rays emitted from the light source assembly 13, so that multiple light rays are generated on the main light paths 11 to realize the beam expansion. The first light rays 1311, the second light rays 1321, and the third light rays 1331 subjected to the beam expansion can be uniformly incident on the light homogenizer 17, and be subjected to secondary homogenization by the light homogenizer 17. The effect of homogenization of the exit light rays from the RGB three-color laser light source synthesis and beam splitting device 1 is improved by using the simple planar structure without adding the separate beam expander. It should be emphasized that the combination of the light splitters 14 and the reflectors 16 has a large number of specific solutions and is not limited to the above-mentioned embodiments, and will not be repeatedly described in detail in the present application.

In summary, the present application provides the RGB three-color laser light source synthesis and beam splitting device 1, having the main light paths 11 extending in the first direction X and the side light paths 12 extending in the second direction Y perpendicular to the first direction X. The RGB three-color laser light source synthesis and beam splitting device 1 includes: the light source assembly 13 including the first light sources 131, the second light source 132, and the third light source 133, where the first light sources 131 are disposed in the main light paths 11 to emit the first light rays 1311 in the first direction X, the second light source 132 is disposed in the side light paths 12 to emit the second light rays 1321 in the second direction Y, and the third light source 133 is disposed in the side light paths 12 to emit the third light rays 1331 in the second direction Y; the light splitters 14 capable of transmitting the portion of the first light rays 1311, the portion of the second light rays 1321, and the portion of the third light rays 1331, and reflecting the remaining portion of the first light rays 1311, the remaining portion of the second light rays 1321, and the remaining portion of the third light rays 1331; the reflectors 16 capable of reflecting the first light rays 1311, the second light rays 1321, and the third light rays 1331; and the light homogenizer 17 capable of uniformly emit the first light rays 1311, the second light rays 1321, and the third light rays 1331; where the light splitters 14 and the reflectors 16 can be capable of conducting the first light rays 1311, the second light rays 1321, and the third light rays 1331 to the light homogenizer 17, and the light homogenizer 17 can enable the first light rays 1311, the second light rays 1321, and the third light rays 1331 to be uniformly emitted from the first direction X. The light splitters 14 and the reflectors 16 are used in combination in the RGB three-color laser light source synthesis and beam splitting device 1 of the present application to perform multi-pass reflection and splitting on the light rays emitted from the light source assembly 13, so that multiple light rays are generated on the main light paths 11 to realize the beam expansion. The first light rays 1311, the second light rays 1321, and the third light rays 1331 subjected to the beam expansion can be uniformly incident on the light homogenizer 17, and be subjected to secondary homogenization by the light homogenizer 17. The effect of homogenization of the exit light rays from the RGB three-color laser light source synthesis and beam splitting device 1 is improved by using the simple planar structure without adding the separate beam expander.

In the present application, the light homogenizer 17 includes a compound eye lens, which achieves uniform emitting of a large area of the light rays while improving the brightness of the light rays. Specifically, in the present application, the compound eye lens is formed by combining a series of microlenses to form a compound eye lens array, and two columns of the compound eye lens array are arranged in parallel. The focus of each small element lens in the first column of compound eye lens arrays coincides with the center of the corresponding small element lens in the second column of compound eye lens arrays, the optical axes of the two columns of compound eye lenses are parallel to each other, and the application of the two columns of compound eye lens arrays to the RGB three-color laser light source synthesis and beam splitting device 1 can obtain high light energy utilization rate and large-area uniform display.

In the present application, the light source assembly 13 includes a laser light source. The first light rays 1311, the second light rays 1321, and the third light rays 1331 are laser light rays of different colors, respectively. For example, the first light rays 1311 is red laser light rays, the second light rays 1321 are green laser light rays, the third light rays 1331 are blue laser light rays, or the like. The colors of the first light rays 1311, the second light rays 1321, and the third light rays 1331 may be interchanged. It is only necessary to ensure that the first light rays 1311, the second light rays 1321, and the third light rays 1331 are laser light rays of different colors, respectively. Details thereof are not repeatedly described in the present application.

In the present application, the light splitters 14 are disposed at an included angle of 45 degree to the first direction X and the second direction Y, respectively, and the reflectors 16 are disposed at an included angle of 45 degree to the first direction X and the second direction Y, respectively. Such arrangement of the light splitters 14 and reflectors 16 can enable the light-receiving surfaces of the light splitters 14 and the light-receiving surfaces of the reflectors 16 to be subjected to the same illumination in the first direction X and the second direction Y, and the light splitters 14 and the reflectors 16 are arranged at an included angle of 45 degree to the first direction and the second direction so that the first light rays 1311, the second light rays 1321 and the third light rays 1331 are mutually transmitted in the first direction X and the second direction Y.

Some embodiments of the present disclosure have been described above to illustrate the present disclosure, but not intended to limit the present disclosure. Those skilled in the art can make various changes and modifications without departing from the spirit and scope of the present disclosure.

What is claimed is:

1. An RGB three-color laser light source synthesis and beam splitting device, having main light paths extending in a first direction and side light paths extending in a second direction perpendicular to the first direction, the device comprising:
a light source assembly comprising a first light source, a second light source, and a third light source, wherein the first light sources is disposed in one of the main light paths to emit first light rays in the first direction, and the second light source and the third light source are disposed in the side light paths to emit second light rays and third light rays in the second direction, respectively;
a light splitter capable of transmitting part of the first light rays while reflecting rest of the first light rays, transmitting part of the second light rays while reflecting rest of the second light rays, and transmitting part of the third light rays while reflecting rest of the third light rays; and
a light filter capable of transmitting one or two of the first light rays, the second light rays, and the third light rays while reflecting rest of the first light rays, the second light rays, and the third light rays; and/or
a reflector capable of reflecting the first light rays, the second light rays, and the third light rays,
wherein the light splitter, the light filters, and/or the reflector are capable of guiding the first light rays, the second light rays, and the third light rays to the first direction;
wherein the main light paths comprise a first main light path and a second main light path, the second main light path is disposed in parallel with the first main light path, the side light paths comprise a first side light path and a second side light path, and the second side light path is disposed in parallel with the first side light path;
the light filters are disposed at an intersection of the first main light path and the first side light path to transmit the first light rays and reflect the second light rays to the first direction;
the light splitters are disposed at an intersection of the first main light path and the second side light path to transmit the portion of the first light rays and reflect the remaining portion of the first light rays to the second direction, transmit the portion of the second light rays and reflect the remaining portion of the second light rays to the second direction, and transmit the portion of the third light rays and reflect the remaining portion of the third light rays to the first direction; and
the reflectors are disposed at an intersection of the second main light path and the second side light path to reflect the first light rays, the second light rays, and the third light rays from the second direction to the first direction;
the light filters are configured to at least transmit the first light rays and reflect the second light rays;
the light splitters are configured to transmit ½ of the first light rays and reflect ½ of the first light rays, transmit ½ of the second light rays and reflect ½ of the second light rays, and transmit ½ of the third light rays and reflect ½ of the third light rays; and
the reflectors are configured to reflect the first light rays, the second light rays, and the third light rays.

2. The RGB three-color laser light source synthesis and beam splitting device of claim 1, wherein the main light paths comprise a first main light path and a second main light path, the second main light path is disposed in parallel with the first main light path, the side light paths comprise a first side light path and a second side light path, and the second side light path is disposed in parallel with the first side light path;
the light splitters comprise a first light splitter and a second light splitter, wherein the first light splitter is disposed at an intersection of the first main light path and the first side light path to transmit the portion of the first light rays and reflect the remaining portion of the first light rays to the second direction, and transmit the portion of the second light rays and reflect the remaining portion of the second light rays to the second direction, and the second light splitter is disposed at an intersection of the first main light path and the second side light path to transmit the first light rays, the second light rays, and the portion of the third light rays, and reflect the remaining portion of the third light rays to the first direction;
the reflectors are disposed at an intersection of the second main light path and the first side light path to reflect the first light rays and the second light rays from the second direction to the first direction; and
the light filters are disposed at an intersection of the second main light path and the second side light path to transmit the first light rays and the second light rays, and reflect the third light rays to the first direction.

3. The RGB three-color laser light source synthesis and beam splitting device of claim 2, wherein
the first light splitter is configured to at least transmit ½ of the first light rays and reflect ½ of the first light rays, and transmit ½ of the second light rays and reflect ½ of the second light rays;
the second light splitter is configured to transmit the first light rays, the second light rays, and ½ of the third light rays and reflect ½ of the third light rays;
the reflectors are configured to at least reflect the first light rays and the second light rays; and
the light filters are configured to transmit the first light rays and the second light rays, and reflect the third light rays.

4. The RGB three-color laser light source synthesis and beam splitting device of claim 1, wherein the main light paths comprise a first main light path, a second main light path, and a third main light path, the first main light path, the second main light path, and the third main light path are disposed parallel to each other, the side light paths comprise a first side light path and a second side light path, and the second side light path is disposed in parallel with the first side light path;
the light filters are disposed at an intersection of the first main light path and the first side light path to transmit the first light rays and reflect the second light rays to the first direction;
the light splitters comprise a first light splitter and a second light splitter, wherein the first light splitter is disposed at an intersection of the first main light path and the second side light path to transmit the portion of the first light rays and reflect the remaining portion of the first light rays to the second direction, transmit the portion of the second light rays and reflect the remaining portion of the second light rays to the second direction, and transmit the portion of the third light rays and reflect the remaining portion of the third light rays to the first direction, and the second light splitter is disposed at an intersection of the second main light path and the second side light path to transmit the portion of the first light rays and reflect the remaining portion of the first light rays to the first direction, transmit the portion of the second light rays and reflect the remaining portion of the second light rays to the first direction, and transmit the portion of the third light rays and reflect the remaining portion of the third light rays to the first direction; and
the reflectors are disposed at an intersection of the third main light path and the second side light path to reflect the first light rays, the second light rays, and the third light rays from the second direction to the first direction.

5. The RGB three-color laser light source synthesis and beam splitting device of claim 4, wherein,
the light filters are configured to at least transmit the first light rays and reflect the second light rays;
the first light splitter is configured to transmit ⅓ of the first light rays and reflect ⅔ of the first light rays, transmit ⅓ of the second light rays and reflect ⅔ of the second light rays, and transmit ⅔ of the third light rays and reflect ⅓ of the third light rays;
the second light splitter is configured to transmit ½ of the first light rays and reflect ½ of the first light rays, transmit ½ of the second light rays and reflect ½ of the second light rays, and transmit ½ of the third light rays and reflect ½ of the third light rays; and
the reflectors are configured to reflect the first light rays, the second light rays, and the third light rays.

6. The RGB three-color laser light source synthesis and beam splitting device of claim 1, wherein the main light paths comprise a first main light path, a second main light path, and a third main light path, the first main light path, the second main light path, and the third main light path are disposed parallel to each other, the side light paths comprise a first side light path and a second side light path, and the second side light path is disposed in parallel with the first side light path;
the light splitters comprise a first light splitter, a second light splitter, a third light splitter, and a fourth light splitter, wherein the first light splitter is disposed at an intersection of the first main light path and the first side light path to transmit the portion of the first light rays and reflect the remaining portion of the first light rays to the second direction, and transmit the portion of the second light rays and reflect the remaining portion of the second light rays to the second direction, the second light splitter is disposed at an intersection of the first main light path and the second side light path to transmit the first light rays, the second light rays, and the portion of the third light rays, and reflect the remaining portion of the third light rays to the first direction, the third light splitter is disposed at an intersection of the second main light path and the first side light path, to transmit the portion of the first light rays and reflect the remaining portion of the first light rays to the second direction, transmit the portion of the second light rays and reflect the remaining portion of the second light rays to the second direction, and the fourth light splitter is disposed at an intersection of the second main light path and the second side light path to transmit the first light rays, the second light rays, and the portion of the third light rays and reflect the remaining portion of the third light rays to the first direction;
the reflectors are disposed at an intersection of the third main light path and the first side light path to reflect the first light rays and the second light rays from the second direction to the first direction; and
the light filters are disposed at an intersection of the third main light path and the second side light path to transmit the first light rays and the second light rays, and reflect the third light rays to the first direction.

7. The RGB three-color laser light source synthesis and beam splitting device of claim 6, wherein
the first light splitter is configured to at least transmit ⅓ of the first light rays and reflect ⅔ of the first light rays, and transmit ⅔ of the second light rays and reflect ⅓ of the second light rays;
the second light splitter is configured to transmit the first light rays, the second light rays, and ⅔ of the third light rays and reflect ⅓ of the third light rays;
the third light splitter is configured to at least transmit ½ of the first light rays and reflect ½ of the first light rays, and transmit ½ of the second light rays and reflect ½ of the second light rays;
the fourth light splitter is configured to transmit the first light rays, the second light rays, and ½ of the third light rays and reflect ½ of the third light rays;
the reflectors are configured to at least reflect the first light rays and the second light rays; and
the light filters are configured to transmit the first light rays and the second light rays, and reflect the third light rays.

8. The RGB three-color laser light source synthesis and beam splitting device of claim 1, wherein the main light paths comprise a first main light path, a second main light path, a third main light path, and a fourth main light path, the first main light path, the second main light path, the third main light path, and the fourth main light path are disposed parallel to each other, the side light paths comprise a first side light path and a second side light path, and the second side light path is disposed in parallel with the first side light path;
the light filters are disposed at an intersection of the first main light path and the first side light path to transmit the first light rays and reflect the second light rays to the first direction;
the light splitters comprise a first light splitter, a second light splitter, and a third light splitter, wherein the first light splitter is disposed at an intersection of the first main light path and the second side light path to transmit the portion of the first light rays and reflect the remaining portion of the first light rays to the second direction, transmit the portion of the second light rays and reflect the remaining portion of the second light rays to the second direction, and transmit the portion of the third light rays and reflect the remaining portion of the third light rays to the first direction, the second light splitter is disposed at an intersection of the second main light path and the second side light path to transmit the portion of the first light rays and reflect the remaining portion of the first light rays to the first direction, transmit the portion of the second light rays and reflect the remaining portion of the second light rays to the first direction, and transmit the portion of the third light rays and reflect the remaining portion of the third light rays to the first direction, and the third light splitter is disposed at an intersection of the third main light path and the second side light path to transmit the portion of the first light rays and reflect the remaining portion of the first light rays to the first direction, transmit the portion of the second light rays and reflect the remaining portion of the second light rays to the first direction, and transmit the portion of the third light rays and reflect the remaining portion of the third light rays to the first direction; and
the reflectors are disposed at an intersection of the fourth main light path and the second side light path to reflect the first light rays, the second light rays, and the third light rays from the second direction to the first direction.

9. The RGB three-color laser light source synthesis and beam splitting device of claim 8, wherein
the light filters are configured to at least transmit the first light rays and reflect the second light rays;
the first light splitter is configured to transmit ¼ of the first light rays and reflect ¾ of the first light rays, transmit ¼ of the second light rays and reflect ¾ of the second light rays, and transmit ¾ of the third light rays and reflect ¼ of the third light rays;
the second light splitter is configured to transmit ⅔ of the first light rays and reflect ⅓ of the first light rays, transmit ⅔ of the second light rays and reflect ⅓ of the second light rays, and transmit ⅔ of the third light rays and reflect ⅓ of the third light rays;
the third light splitter is configured to transmit ½ of the first light rays and reflect ½ of the first light rays, transmit ½ of the second light rays and reflect ½ of the second light rays, and transmit ½ of the third light rays and reflect ½ of the third light rays; and
the reflectors are configured to reflect the first light rays, the second light rays, and the third light rays.

10. An RGB three-color laser light source synthesis and beam splitting device, having main light paths extending in a first direction and side light paths extending in a second direction perpendicular to the first direction, the device comprising:
a light source assembly comprising a first light source, a second light source, and a third light source, wherein the first light sources is disposed in one of the main light paths to emit first light rays in the first direction, and the second light source and the third light source are disposed in the side light paths to emit second light rays and third light rays in the second direction, respectively;
a light splitter capable of transmitting part of the first light rays while reflecting rest of the first light rays, transmitting part of the second light rays while reflecting rest of the second light rays, and transmitting part of the third light rays while reflecting rest of the third light rays; and
a light filter capable of transmitting one or two of the first light rays, the second light rays, and the third light rays while reflecting rest of the first light rays, the second light rays, and the third light rays; and/or
a reflector capable of reflecting the first light rays, the second light rays, and the third light rays,
wherein the light splitter, the light filters, and/or the reflector are capable of guiding the first light rays, the second light rays, and the third light rays to the first direction; and
wherein the main light paths comprise a first main light path and a second main light path, the second main light path is disposed in parallel with the first main light path, the side light paths comprise a first side light path and a second side light path, and the second side light path is disposed in parallel with the first side light path; and
the first light sources are disposed in the first main light path and the second main light path, respectively, the second light source is disposed in the first side light path, and the third light source is disposed in the second side light path;
wherein the light splitters comprise a first light splitter and a second light splitter, wherein the first light splitter is disposed at an intersection of the first main light path and the first side light path to transmit the first light ray and the portion of the second light rays and reflect the remaining portion of the second light rays to the second direction, and the second light splitter is disposed at an intersection of the first main light path and the second side light path to transmit the first light rays, the second light rays, and the portion of the third light rays, and reflect the remaining portion of the third light rays to the first direction; and
the light filters comprise a first light filter and a second filter element, wherein the first light filter is disposed at an intersection of the second main light path and the first side light path to transmit the first light rays and reflect the second light rays to the first direction, and the second light filter is disposed at an intersection of the second main light path and the second side light path to transmit the first light rays and the second light rays, and reflect the third light rays to the first direction.

11. The RGB three-color laser light source synthesis and beam splitting device of claim 10, wherein the first light splitter is configured to at least transmit the first light rays and ½ of the second light rays and reflect ½ of the second light rays;
the second light splitter is configured to transmit the first light rays, the second light rays, and ½ of the third light rays and reflect ½ of the third light rays;
the first light filter is configured to at least transmit the first light rays and reflect the second light rays; and
the second light filter is configured to transmit the first light rays and the second light rays, and reflect the third light rays.

12. The RGB three-color laser light source synthesis and beam splitting device of claim 10, wherein the first light source, the second light source, and the third light source all have the same luminous intensity.

13. The RGB three-color laser light source synthesis and beam splitting device of claim 10, wherein the sum of the luminous brightness of the first light source disposed in the first main light path and the luminous brightness of the first light source disposed in the second main light path is the same as the luminous brightness of the second light source; and
the sum of the luminous brightness of the first light source disposed in the first main light path and the luminous brightness of the first light source disposed in the second main light path is the same as the luminous brightness of the third light source.

14. The RGB three-color laser light source synthesis and beam splitting device of claim 10, wherein the main light paths comprise a first main light path, a second main light path, and a third main light path, the first main light path, the second main light path, and the third main light path are disposed parallel to each other, the side light paths comprise a first side light path and a second side light path, and the second side light path is disposed in parallel with the first side light path; and
the first light sources are disposed in the first main light path, the second main light path, and the third main light path, respectively, the second light source is disposed in the first side light path, and the third light source is disposed in the second side light path.

15. The RGB three-color laser light source synthesis and beam splitting device of claim 14, wherein the light splitters comprise a first light splitter, a second light splitter, a third light splitter, and a fourth light splitter;
the light splitters comprise a first light splitter, a second light splitter, a third light splitter, and a fourth light splitter, wherein the first light splitter is disposed at an intersection of the first main light path and the first side light path to transmit the first light rays and the portion of the second light rays and reflect the remaining portion of the second light rays to the second direction, the second light splitter is disposed at an intersection of the first main light path and the second side light path to transmit the first light rays, the second light rays, and the portion of the third light rays, and reflect the remaining portion of the third light rays to the first direction, the third light splitter is disposed at an intersection of the second main light path and the first side light path, to transmit the first light rays and the portion of the second light rays and reflect the remaining portion of the second light rays to the second direction, and the fourth light splitter is disposed at an intersection of the second main light path and the second side light path to transmit the first light rays, the second light rays, and the portion of the third light rays and reflect the remaining portion of the third light rays to the first direction;
the light filters comprise a first light filter and a second light filter, wherein the first light filter is disposed at an intersection of the third main light path and the first side light path to transmit the first light rays and reflect the second light rays to the first direction, and the second light filter is disposed at an intersection of the third main light path and the second side light path to transmit the first light rays and the second light rays, and reflect the third light rays to the first direction.

16. The RGB three-color laser light source synthesis and beam splitting device of claim 15, wherein the first light splitter is configured to at least transmit the first light rays and ⅓ of the second light rays and reflect ⅔ of the second light rays;
the second light splitter is configured to transmit the first light rays, the second light rays, and ⅔ of the third light rays and reflect ⅓ of the third light rays;
the third light splitter is configured to at least transmit the first light rays and ½ of the second light rays, and reflect ½ of the second light rays;
the fourth light splitter is configured to transmit the first light rays, the second light rays, and ½ of the third light rays and reflect ½ of the third light rays;
the first light filter is configured to at least transmit the first light rays and reflect the second light rays; and
the second light filter is configured to transmit the first light rays and the second light rays, and reflect the third light rays.

17. The RGB three-color laser light source synthesis and beam splitting device of claim 14, wherein the first light source, the second light source, and the third light source all have the same luminous intensity.

18. The RGB three-color laser light source synthesis and beam splitting device of claim 14, wherein the sum of the luminous brightness of the first light source disposed in the first main light path, the luminous brightness of the first light source disposed in the second main light path, and the luminous brightness of the first light source disposed in the third main light path is the same as the luminous brightness of the second light source; and
the sum of the luminous brightness of the first light source disposed in the first main light path, the luminous brightness of the first light source disposed in the second main light path, and the luminous brightness of the first light source disposed in the third main light path is the same as the luminous brightness of the third light source.

19. An RGB three-color laser light source synthesis and beam splitting device, having main light paths extending in a first direction and side light paths extending in a second direction perpendicular to the first direction, the device comprising:
a light source assembly comprising a first light source, a second light source, and a third light source, wherein the first light sources is disposed in one of the main light paths to emit first light rays in the first direction, and the second light source and the third light source are disposed in the side light paths to emit second light rays and third light rays in the second direction, respectively;
a light splitter capable of transmitting part of the first light rays while reflecting rest of the first light rays, transmitting part of the second light rays while reflecting rest of the second light rays, and transmitting part of the third light rays while reflecting rest of the third light rays; and
a light filter capable of transmitting one or two of the first light rays, the second light rays, and the third light rays while reflecting rest of the first light rays, the second light rays, and the third light rays; and/or
a reflector capable of reflecting the first light rays, the second light rays, and the third light rays,
wherein the light splitter, the light filters, and/or the reflector are capable of guiding the first light rays, the second light rays, and the third light rays to the first direction; and
wherein the main light paths comprise a first main light path, a second main light path, and a third main light path, the first main light path, the second main light path, and the third main light path are disposed parallel to each other, the side light paths comprise a first side light path and a second side light path, and the second side light path is disposed in parallel with the first side light path;
the light splitters comprise a first light splitter and a second light splitter, wherein the first light splitter is disposed at an intersection of the first main light path and the first side light path and extends to an intersection of the second main light path and the second side light path to transmit the portion of the first light rays and reflect the remaining portion of the first light rays, transmit the portion of the second light rays and reflect the remaining portion of the second light rays, and transmit the portion of the third light rays and reflect the remaining portion of the third light rays, and the second light splitter is disposed at an intersection of the first main light path and the second side light path to transmit the first light rays, the second light rays, and the portion of the third light rays, and reflect the remaining portion of the third light rays to the first direction; and
the reflectors are disposed at an intersection of the second main light path and the first side light path and extends to an intersection of the third main light path and the second side light path to reflect the first light rays, the second light rays, and the third light rays from the second direction to the first direction;
wherein
the first light splitter is configured to transmit ½ of the first light rays and reflect ½ of the first light rays, transmit ½ of the second light rays and reflect ½ of the second light rays, and transmit ½ of the third light rays and reflect ½ of the third light rays;
the second light-splitting is configured to transmit ⅔ of the first light rays and reflect ⅓ of the first light rays, transmit ⅔ of the second light rays and reflect ⅓ of the second light rays, and transmit ⅔ of the third light rays and reflect ⅓ of the third light rays; and
the reflectors are configured to reflect the first light rays, the second light rays, and the third light rays.

20. The RGB three-color laser light source synthesis and beam splitting device of claim 19, wherein the main light paths comprise a first main light path, a second main light path, and a third main light path, the first main light path, the second main light path, and the third main light path are disposed parallel to each other, the side light paths comprise a first side light path and a second side light path, and the second side light path is disposed parallel to the first side light path;
the light splitters comprise a first light splitter, a second light splitter, and a third light splitter, wherein the first light splitter is disposed at an intersection of the first main light path and the first side light path to transmit the portion of the first light rays and reflect the remaining portion of the first light rays to the second direction, and transmit the portion of the second light rays and reflect the remaining portion of the second light rays to the second direction, the second light splitter is disposed at an intersection of the first main light path and the second side light path to transmit the first light rays, the second light rays, and the portion of the third light rays, and reflect the remaining portion of the third light rays to the first direction, the third light splitter is disposed at an intersection of the second main light path and the second side light path, to transmit the portion of the first light rays and reflect the remaining portion of the first light rays to the second direction, transmit the portion of the second light rays and reflect the remaining portion of the second light rays to the second direction, and transmit the portion of the third light rays and reflect the remaining portion of the third light rays to the first direction; and
the reflectors comprise a first reflector and a second reflector, wherein the first reflector is disposed at an intersection of the second main light path and the first side light path to reflect the first light rays and the second light rays from the second direction to the first direction, and the second reflector is disposed at an intersection of the third main light path and the second side light path to reflect the first light rays, the second light rays and the third light rays from the second direction to the first direction.

21. The RGB three-color laser light source synthesis and beam splitting device of claim 20, wherein
the first light splitter is configured to at least transmit ⅓ of the first light rays and reflect ⅔ of the first light rays, and transmit ⅔ of the second light rays and reflect ⅓ of the second light rays;
the second light splitter is configured to transmit the first light rays, the second light rays, and ⅔ of the third light rays and reflect ⅓ of the third light rays;
the third light splitter is configured to at least transmit ½ of the first light rays and reflect ½ of the first light rays, transmit ½ of the second light rays and reflect ½ of the second light rays, and transmit ½ of the third light rays and reflect ½ of the third light rays;
the first reflector is configured to at least reflect the first light rays and the second light rays; and
the second reflector is configured to reflect the first light rays, the second light rays, and the third light rays.

22. The RGB three-color laser light source synthesis and beam splitting device of claim 19, wherein the main light paths comprise a first main light path, a second main light path, a third main light path, and a fourth main light path, the first main light path, the second main light path, the third main light path, and the fourth main light path are disposed parallel to each other, the side light paths comprise a first side light path and a second side light path, and the second side light path is disposed in parallel with the first side light path;
the light splitters comprise a first light splitter, a second light splitter, a third light splitter, a fourth light splitter, and a fifth light splitter, wherein the first light splitter is disposed at an intersection of the first main light path and the first side light path to transmit the portion of the first light rays and reflect the remaining portion of the first light rays to the second direction, and transmit the portion of the second light rays and reflect the remaining portion of the second light rays to the second direction, the second light splitter is disposed at an intersection of the first main light path and the second side light path to transmit the first light rays, the second light rays, and the portion of the third light rays, and reflect the remaining portion of the third light rays to the first direction, the third light splitter is disposed at an intersection of the second main light path and the second side light path, to transmit the portion of the first light rays and reflect the remaining portion of the first light rays to the second direction, transmit the portion of the second light rays and reflect the remaining portion of the second light rays to the second direction, the fourth light splitter is disposed at an intersection of the second main light path and the second side light path to transmit the first light rays, the second light rays, and the portion of the third light rays and reflect the remaining portion of the third light rays to the first direction, and the fifth light splitter is disposed at an intersection of the second main light path and the second side light path to transmit the portion of the first light rays and reflect the remaining portion of the first light rays to the second direction, transmit the portion of the second light rays and reflect the remaining portion of the second light rays to the second direction, and transmit the portion of the third light rays and reflect the remaining portion of the third light rays to the first direction; and
the reflectors comprise a first reflector and a second reflector, wherein the first reflector is disposed at an intersection of the third main light path and the first side light path to reflect the first light rays and the second light rays from the second direction to the first direction, and the second reflector is disposed at an intersection of the fourth main light path and the second side light path to reflect the first light rays, the second light rays and third light rays from the second direction to the first direction.

23. The RGB three-color laser light source synthesis and beam splitting device of claim 22, wherein
the first light splitter is configured to at least transmit ¼ of the first light rays and reflect ¾ of the first light rays, and transmit ¾ of the second light rays and reflect ¼ of the second light rays;
the second light splitter is configured to transmit the first light rays, the second light rays, and ¾ of the third light rays and reflect ¼ of the third light rays;
the third light splitter is configured to at least transmit ⅓ of the first light rays and reflect ⅔ of the first light rays, and transmit ⅔ of the second light rays and reflect ⅓ of the second light rays;
the fourth light splitter is configured to transmit the first light rays, the second light rays, and ⅔ of the third light rays and reflect ⅓ of the third light rays;
the fifth light splitter is configured to at least transmit ½ of the first light rays and reflect ½ of the first light rays, transmit ½ of the second light rays and reflect ½ of the second light rays, and transmit ½ of the third light rays and reflect ½ of the third light rays;
the first reflector is configured to at least reflect the first light rays and the second light rays; and
the second reflector is configured to reflect the first light rays, the second light rays, and the third light rays.

24. The RGB three-color laser light source synthesis and beam splitting device of claim 19, further comprising:
a light homogenizer capable of uniformly emitting the first light rays, the second light rays, and the third light rays,
wherein the light splitters, the light filters, and the reflectors are capable of conducting the first light rays, the second light rays, and the third light rays to the light homogenizer, and the light homogenizer enables the first light rays, the second light rays, and the third light rays to be uniformly emitted from the first direction.

25. The RGB three-color laser light source synthesis and beam splitting device of claim 24, wherein the light homogenizer comprises a compound eye lens.

26. The RGB three-color laser light source synthesis and beam splitting device of claim 1, wherein the light source assembly comprises a laser light source; and
the first light rays, the second light rays, and the third light rays are laser light rays of different colors, respectively.

27. The RGB three-color laser light source synthesis and beam splitting device of claim 1, wherein the light filters are disposed at an included angle of 45 degree to the first direction and the second direction, respectively;
the light splitters are disposed at an included angle of 45 degree to the first direction and the second direction, respectively; and
the reflectors are disposed at an included angle of 45 degree to the first direction and the second direction, respectively.
